(19) United States
(12) Patent Application Publication
(10) Pub. No.: US 2019/0034540 A1
(43) Pub. Date: Jan. 31, 2019

(54) NATURAL LANGUAGE SEARCH WITH SEMANTIC MAPPING AND CLASSIFICATION

(71) Applicant: Insight Engines, Inc., San Francisco, CA (US)

(72) Inventors: Jacob A. PERKINS, San Francisco, CA (US); Aaron COLEMAN, San Francisco, CA (US); Grant M. WERNICK, San Francisco, CA (US)

(73) Assignee: Insight Engines, Inc., San Francisco, CA (US)

(21) Appl. No.: 16/037,885

(22) Filed: Jul. 17, 2018

Related U.S. Application Data
(60) Provisional application No. 62/538,169, filed on Jul. 28, 2017.

(51) Int. Cl. G06F 17/30

(52) U.S. Cl. CPC G06F 17/30867; G06F 17/30321; G06F 17/3097

(57) ABSTRACT

The usefulness of a search engine depends, among other things, on ease of use in ad hoc queries. This is particularly challenging in security and operations domains. One thing that makes it challenging is late binding schemas that encourage revision of schemas on the fly. The technology disclosed has been applied in security and operations domains, with late binding schemas, to translate domain specific natural language queries into executable search queries.

### RELATED APPLICATIONS

This application claims priority to U.S. Provisional Patent Application 62/538,169, entitled “Expanding Domain Specific Natural Language Queries to Executable SPL,” filed on Jul. 28, 2017 (Attorney Docket No. WEOT 1004-1). Further, this application is related to U.S. Provisional Patent Application No. 62/171,971, entitled, “Natural Language Search with Semantic Mapping and Classification,” filed on Jun. 5, 2015 (Attorney Docket No. WEOT 1003-1) and is related to U.S. patent application Ser. No. 15/147,113, entitled, “Natural Language Search with Semantic Mapping and Classification,” filed on May 5, 2016 (Attorney Docket No. WEOT 1003-2). The applications are hereby incorporated by reference for all purposes.

### BACKGROUND

The disclosed technology relates to implementing natural language search with semantic mapping and classification; that is, discerning the intent of a user's search query and returning relevant search results.

Many general purpose search engines are designed to search for information on large data sets like the World Wide Web, with search results presented as search engine results summaries, web pages, images and other types of files. Some search engines also mine data available in databases or open directories, and maintain real-time information by running an automated web crawler which follows the links on a site.

For example, when a user enters a query into a general purpose search engine (typically by using one or more keywords), the engine examines its index and provides a listing of best-matching web pages according to its criteria, usually with a short summary containing the document's title and sometimes parts of the text. Most search engines support the use of the Boolean operators, and some search engines provide an advanced feature called proximity search, which allows users to define the distance between keywords. There is also concept-based searching where the research involves using statistical analysis on pages containing the words or phrases for which a user searches. As well, natural language queries allow the user to enter a question in the form one would ask to a human.

A natural language search engine would, in theory, find targeted answers to user questions (as opposed to keyword search). For example, when confronted with a question of the form ‘which U.S. state has the highest income tax?’, conventional search engines ignore the question and instead search on the keywords ‘state’, ‘income’ and ‘tax’.

Natural language search, on the other hand, attempts to use natural language processing to understand the nature and context of the question, more specifically the underlying intent of the user's question, and then to search and return a subset of the web that contains the answer to the question. Because natural language search can apply semantic processing to a user's query, its results would have a higher relevance than results from a keyword search engine. This can be especially useful in searching smaller data sets to which it may be difficult to apply brute force keyword or statistical search methods that rely on title match, category lookup, and keyword frequency, which are insufficient for all but the simplest queries.

An opportunity arises to develop better systems and methods for implementing natural language search with semantic mapping and classification.

### SUMMARY

The disclosed technology relates to implementing natural language search with semantic mapping and classification. The technology further discloses systems and methods for querying domain specific databases and other available data sources.

Particular aspects of the technology disclosed are described in the claims, specification and drawings.

### BRIEF DESCRIPTION OF THE DRAWINGS

The patent application file contains at least one drawing executed in color. Copies of this patent application publication with color drawing(s) will be provided by the Office upon request and payment of the necessary fee. The color drawings also may be available in PAIR via the Supplemental Content tab.

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 illustrates one implementation of an environment for implementing natural language search with semantic mapping and classification.

FIG. 2 is a high level block diagram showing the major components of the technologies disclosed herein.

FIGS. 3A, 3B, 3C and 3D show natural language queries and their corresponding SPL queries.

FIGS. 4, 5 and 6 are screenshots of three use cases used in a performance study for the technology disclosed.

FIG. 7A shows an example of a sequence of transformations for translating a natural language query to a machine executable query.

FIG. 7B shows the same query as translated to SPL, SQL and MongoDB.

FIG. 8 shows a flow chart of natural language parser and disambiguator 115 that performs natural language query analysis 710 and generates a parse tree 730.

FIG. 9 shows a block diagram of a classification extraction module.

FIGS. 10A and 10B show an implementation of Python code that disambiguates search input.

FIGS. 11 and 12 show Python code for that handles “for” and “with”, and conjunctions.

FIG. 13 shows an example set of transformations from natural language input to disambiguated semantic mappings.

FIGS. 14, 15A, 15B, 16A, 16B, 17 and 18 show example screenshots of results from queries that use time series index data.

FIG. 19 shows an example computer system used for natural language search with semantic mapping and classification.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Most search problems can be formulated in terms of search space and target. It is a significant advancement to identify a specific, defined search space of interest for a query. For example, a local search space can be utilized for quickly answering difficult questions like, ‘What's happening this weekend in the city?’ ‘What restaurants do my friends like in Portland?’ or ‘What can we do with the kids, that's open right now?’ In the cybersecurity domain, an example of this would be ‘Find all endpoints which have been infected by a virus in the past month.’ These are very specific queries that have implicit context.

One difference between domain specific queries and general queries is that in a general query the vocabulary can be large and unconstrained, for instance on the internet, versus the vocabulary in a selected domain which often takes the form of specialized jargon. In the former case, a data set can be widely varied and rapidly changing. In the domain specific case, data sets can be more uniform and change more slowly by comparison.

Further, in some cases, domain specific data sets may be smaller and may not lend themselves to the application of statistical methods that depend largely on keyword and key phrase frequencies. This is where semantic understanding that reveals relationships among words and phrases can provide the key to applying natural language processing effectively.

Search problems in a particular domain require an understanding of the user's intent that traditional search methods lack, including a sense of time, domain and situational context, user preferences and the history of previous searches in the domain of interest. In an age in which talking to technology is becoming the norm and user expectations are skyrocketing, semantic search is more important than ever.

One area of growing interest emerges from the use of computing and communications technology in securing information and physical resources as well as managing the information technology (“IT”) operations themselves. At the present time there is a pressing need for more security and IT professionals to manage and secure these resources. The learning curve for conventional tools requires extensive training and often programming skills.

The tools themselves utilize complicated, non-intuitive interfaces and often require intimate knowledge of the underlying data to perform even the simplest searches. When dashboards and visualizations are provided they are of limited flexibility and in many cases provide only preset or fixed views of data. IT environments have become so complex with diverse log sources that state of the art tools from Splunk™ provide so-called late binding schemas that can be modified immediately before a query or before a follow up query. So much data is collected that schema refinement is postponed until query time. This complicates translation of natural language query into executable query language. Even if the user has the requisite skills, it can take a relatively long time, perhaps several hours, to design and write a query to answer a simple question like “Which systems have had 10 failed logins followed by a successful one this week?”

In sharp contrast, the technology disclosed provides a natural language interface that can accept this query stated exactly as above, and return results in seconds. Further, there is no need for the user or analyst to write the code that specifies the query. Certainly this can increase the effectiveness of skilled cyber security analysts or IT operations staff. Additionally, by providing a natural language interface, the technology disclosed can unleash the potential of security professionals and others skilled in following leads and asking appropriate questions but lacking formal training to utilize these sophisticated IT tools.

As an example, physical security specialists, with minimal training, can quickly begin to pursue and explore cyber security issues. Such specialists already have experience and skill in identifying leads and following them. They know the questions to ask to investigate an incident. Using the technology disclosed, they are thus enabled to apply their existing skills in the cyber security domain without the need for extensive training. Thus, they can quickly provide additional resources to manage and remediate the burgeoning security and IT issues that continue to affect us worldwide. As will be described below, actual performance tests were conducted with physical security specialists to validate and measure the major improvements in effectiveness obtained using the technology disclosed.

Ultimately, the quest to provide more user-friendly interfaces for searching and managing complex systems will drive the need for semantic query understanding and search relevancy to dominate as search requirements. The disclosed technology offers a customizable flexible technology designed to be taught about a domain and to be able to systematically adapt to its unique needs.

### Environment

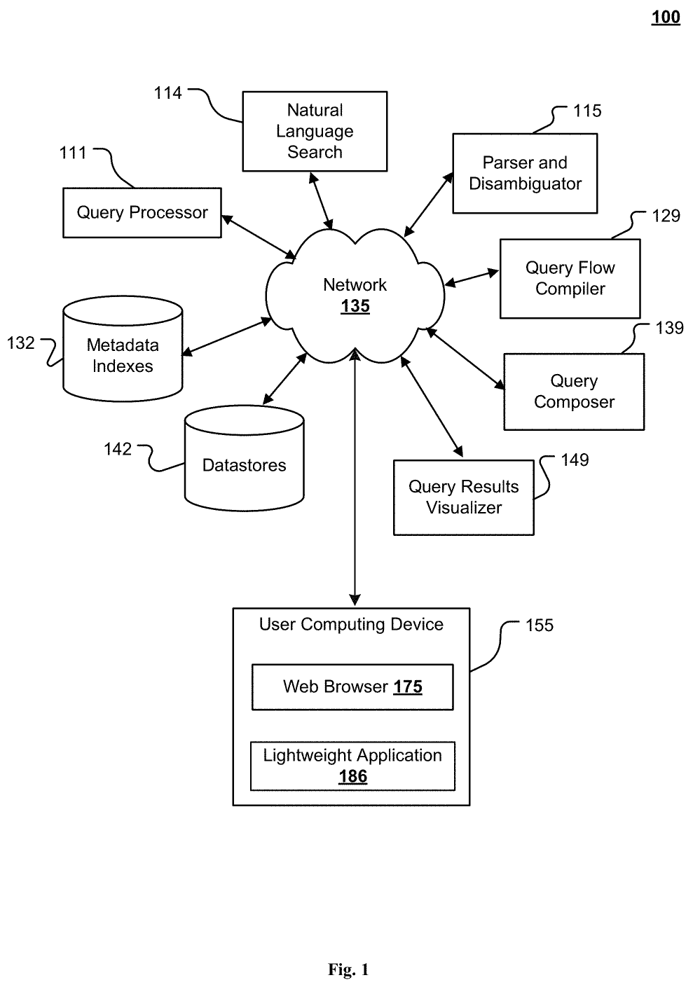

FIG. 1 illustrates one implementation of a natural language search with semantic mapping and classification environment 100 that includes natural language search module 114, natural language parser and disambiguator 115, query flow compiler 129, query composer 139, query results visualizer 149, query processor 111, metadata indexes 132, datastores 142, network 135 and user computing device 155.

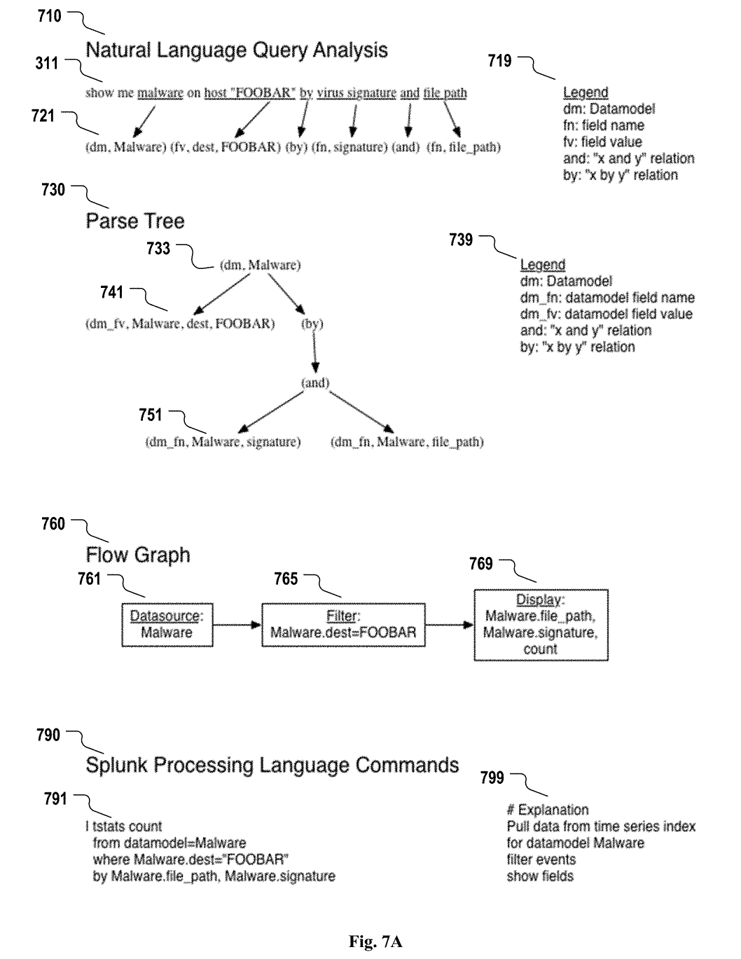

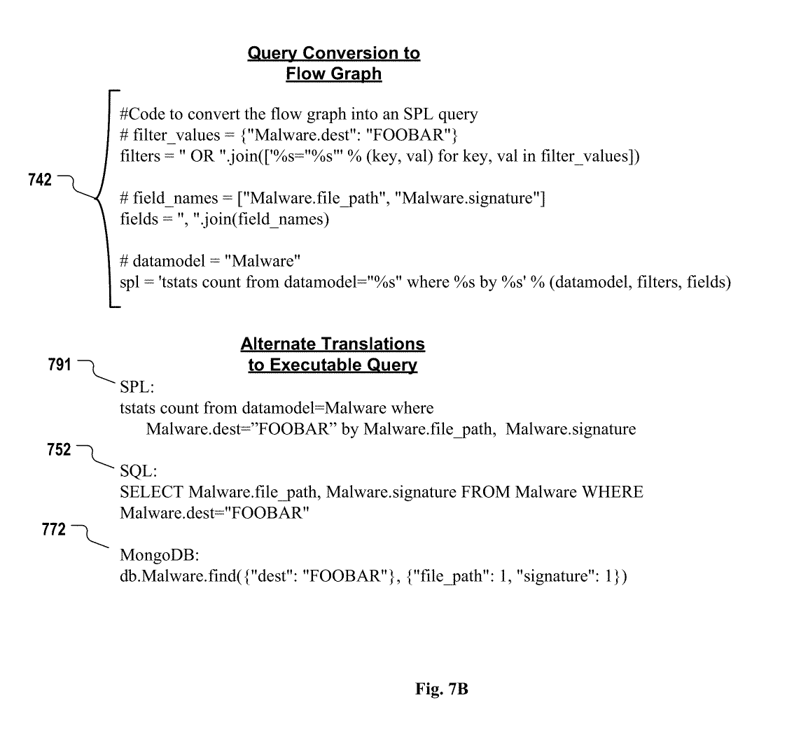

Parser and disambiguator 115 accepts input from a search requestor (for example, a question to be answered, or a phrase that describes what is desired) and transforms it into a parse tree 730 in FIG. 7A that describes semantic relationships among the words and phrases in the input. Input can be via spoken words, text entered by a user, or by another input mechanism. Domain specific jargon can be identified and used to build semantic relationships with other words and phrases in a query.

Query flow compiler 129 receives the parse tree 730 in FIG. 7A from the natural language parser and disambiguator 115 and outputs a flow graph that describes what data source to use, what filters to apply to the data and what results to retrieve for display.

Query composer 139 receives the flow graph from the query flow compiler 129 and generates a search specification in the form of a database query specification that can be used to run the search.

Query processor 111 receives the query specification and executes it by attempting to retrieve the indicated data from metadata indexes 132 and datastores 142. Final results are processed by query results visualizer 149 to produce one or more views of the data, which can be displayed on user computing device 155. This user computing device 155 may also allow the user to issue a natural language query and view the results using a web browser 175 or lightweight application 186.

Metadata indexes 132 can be used to accelerate queries by providing indexed access to data that are frequently requested. In the example implementation given, a schema is provided to extract and format data from datastores 142 into metadata indexes 132. The data are extracted and stored in a time series index with a slight delay after being stored in a main datastore. The extraction is specified using SPL (the search processing language provided by Splunk™) an SQL-like structured query language based on a relational data model.

In some implementations indexed data may be included and stored with the indexes. Alternatively, the data may be accessible physically on the same computing system, or it could be virtually available and proximal via a high speed link. The advantage of providing time series indexed data is that queries based on time and location are common, whether searching for a restaurant for dinner or investigating a security incident. Thus, providing indexes for these can allow results to be obtained significantly faster.

Datastores 142 are repositories for data collected from data sources available to the system. Datastores 142 may reside on the same machine as the metadata indexes 132, accessible virtually via a communication network or both, as there can be multiple datastores. Sources of data include system logs, security event logs, threat feeds, identity databases (e.g. LDAP, local directory access protocol), specialized organizational data sources, etc.

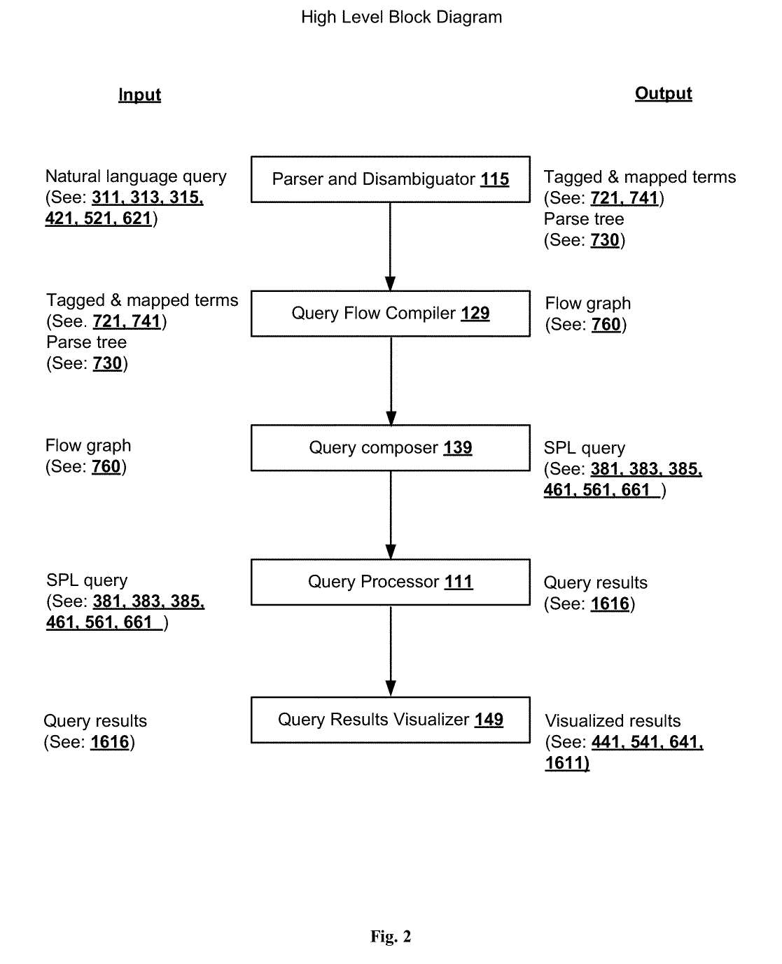

FIG. 2 shows a high level block diagram of the major components of the technology disclosed herein that transforms a natural language query into a machine executable query yielding results that can be visualized for a user.

Natural language search module 114 captures a query from a user or another machine or system. The query is captured as text in the implementation shown. However, a query may be entered by speaking to a machine that captures audio and converts spoken language or sounds to text. In other implementations, text queries may be predefined and taken from a list by a user or they could be selected programmatically by an application. In yet other implementations, queries could be generated dynamically by an application and input to the natural language search module 114.

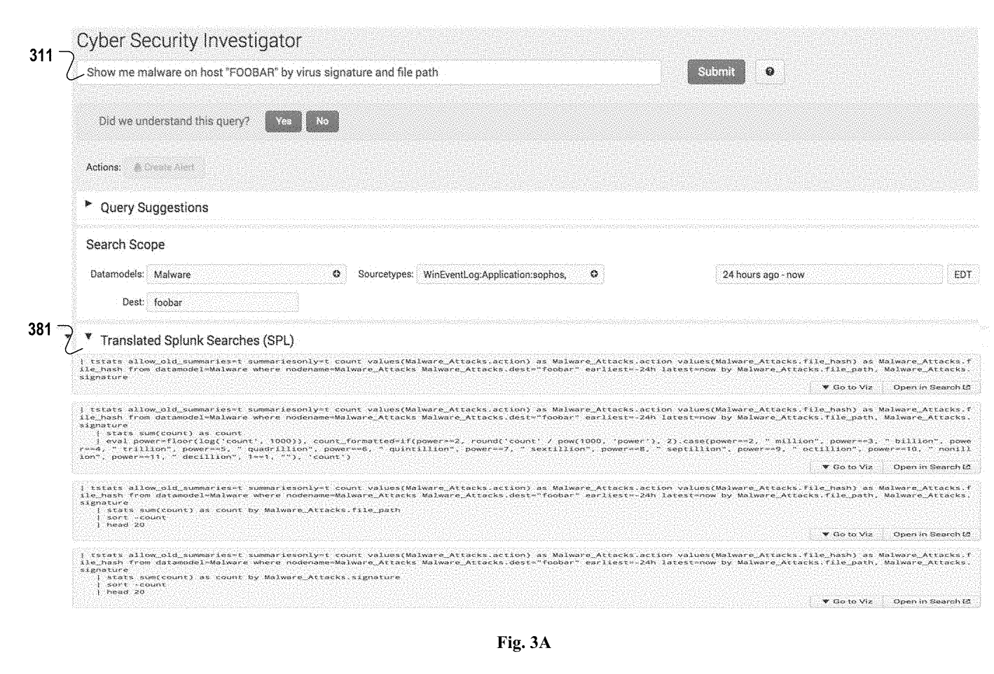

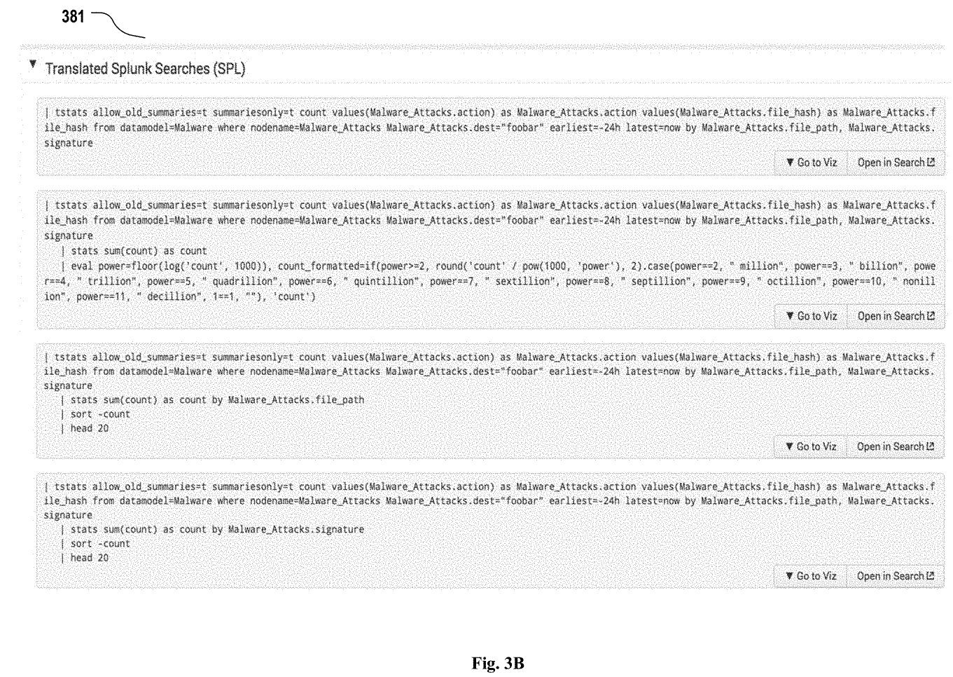

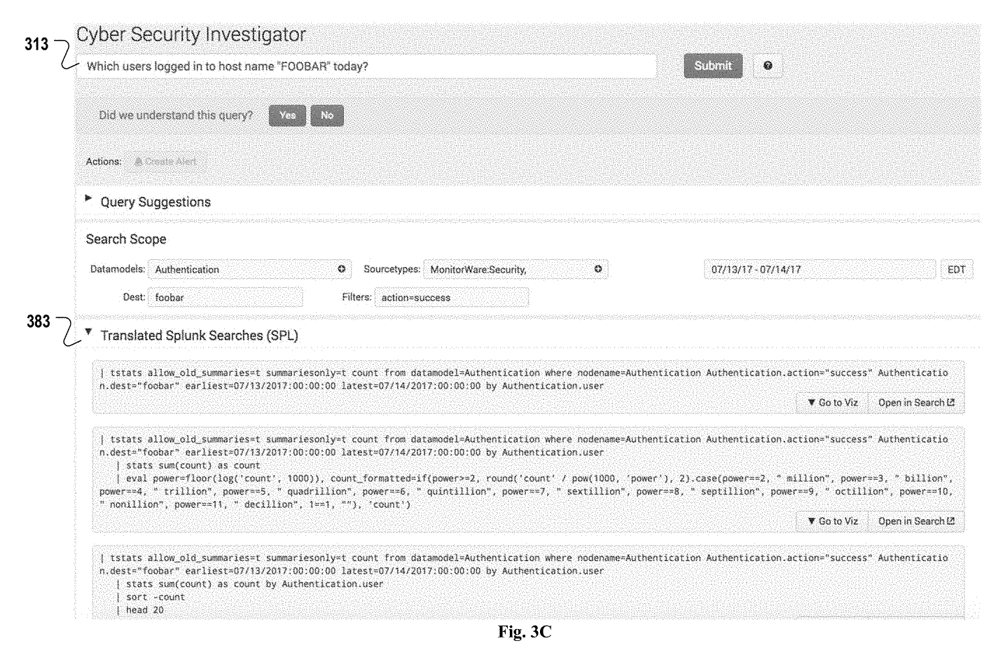

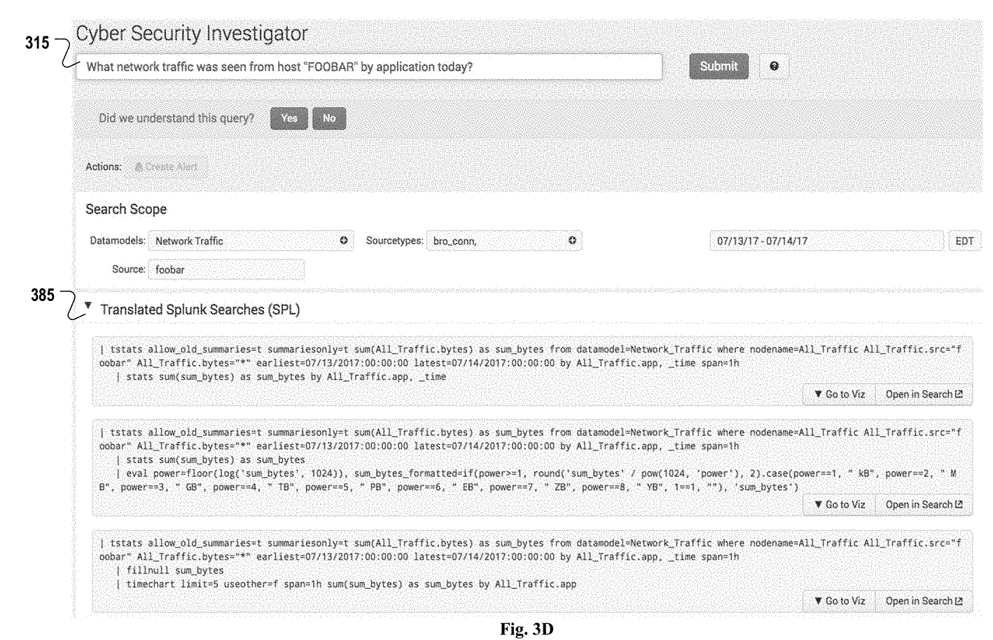

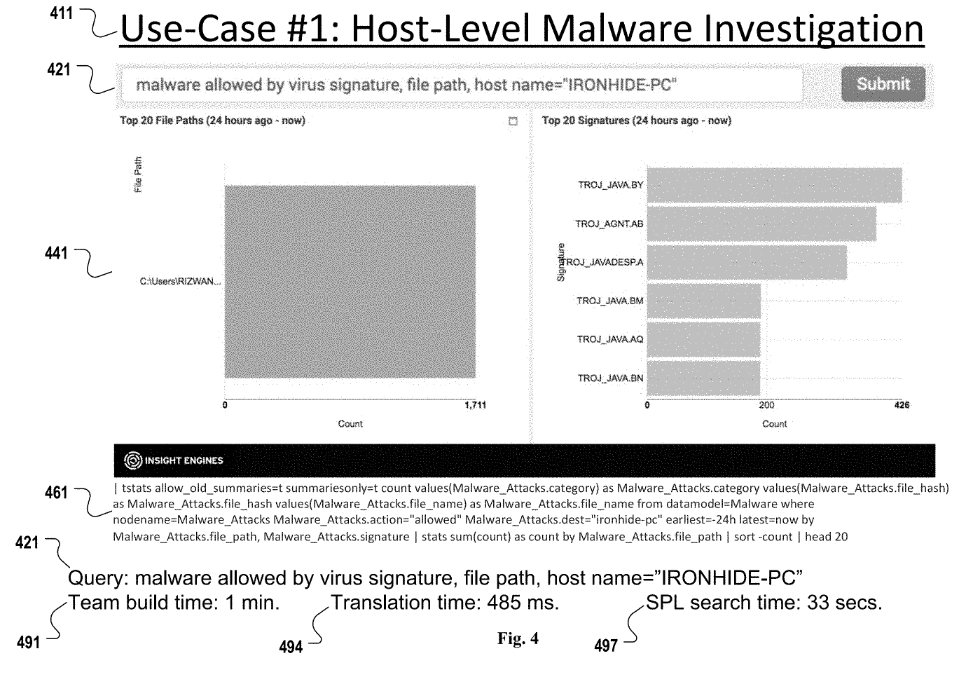

Natural language parser and disambiguator 115 receives as input a natural language query from the natural language search module 114. Examples are noted: 311, 313 and 315 show example queries from FIGS. 3A-3D; 421, 521 and 621 show example queries from the use cases described in FIGS. 4-6.

Consider natural language query 311 “Show me malware on host ‘FOOBAR’ by virus signature and file path.” This query is searching for malware, i.e. malicious software that includes viruses, rootkits, adware, spyware, and the like, on a system named “FOOBAR.” This kind of query is common for both IT operations troubleshooting and cybersecurity investigations and may be prompted, for instance, by slow system response or an actual malware incident.

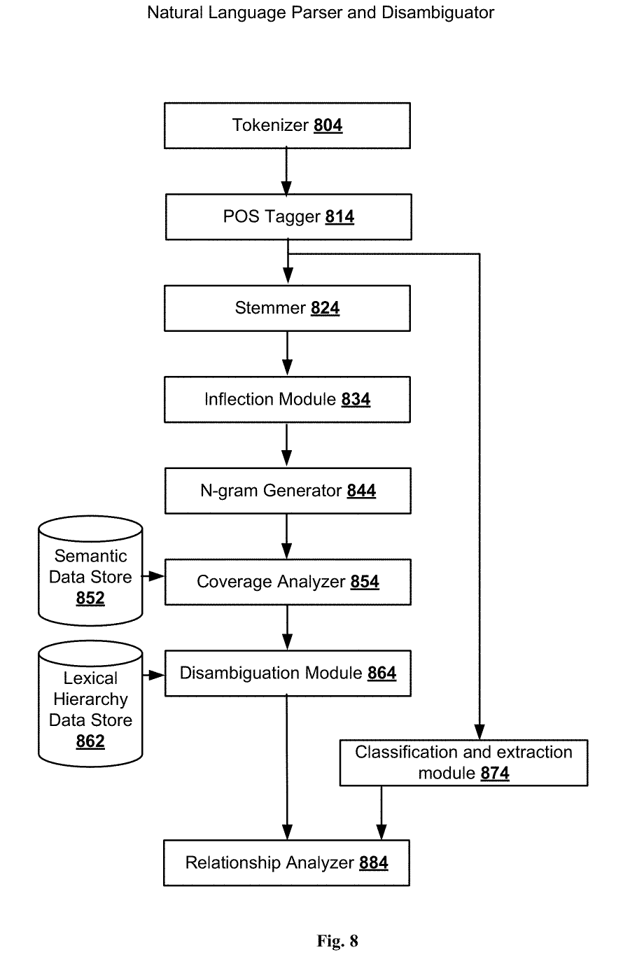

The natural language parser and disambiguator 115 in FIG. 1 expands a query to identify and tag words and phrases with search parameter mapping codes and values. Tagged and mapped terms (e.g., tuples) 721 and 741 are shown in FIG. 7A. These are checked for semantic validity and used to create a parse tree 730 that formalizes the relationships among them. A description of the natural language parser and disambiguator is given in FIG. 8. The parse tree 730 for the above query is shown in FIG. 7A, which illustrates a sequence of transformations for translating a natural language query to a machine executable query.

The query flow compiler 129 receives the parse tree 730 in FIG. 7A including the tagged and mapped terms from the parser and disambiguator 115 and outputs a flow graph that describes what data source to use, what filters to apply to the data and what results to retrieve for display. The flow graph for the above example query is shown as 760 in FIG. 7A.

The query composer 139 receives the flow graph 760 and generates a query specification that specifies what data to retrieve from metadata indexes 132 and datastores 142. Examples are noted: 381, 383 and 385 show example queries from FIGS. 3A-3D; 461, 561 and 661 show example queries from the use cases described in FIGS. 4-6.

The query specification can be output in a query language such as SQL (structured query language) or a similar language. FIG. 7B shows the query 311 in FIG. 7A translated to SPL, SQL and MongoDB. In alternate implementations, other query languages or database access methods can be used to specify a query.

Many languages similar to SQL have been created, owing to its large install base, familiarity and flexibility of use: SQL and SQL-like interfaces allow data to be saved in many different formats but treated as if stored in a relational database comprising tables, fields and values.

One such language is SPL (search programming language) created by Splunk™ Their products are centered around their proprietary databases, which are used by many large enterprises to log system activity and events for operational and cybersecurity purposes. FIGS. 3A-3D show natural language queries and their corresponding SPL queries.

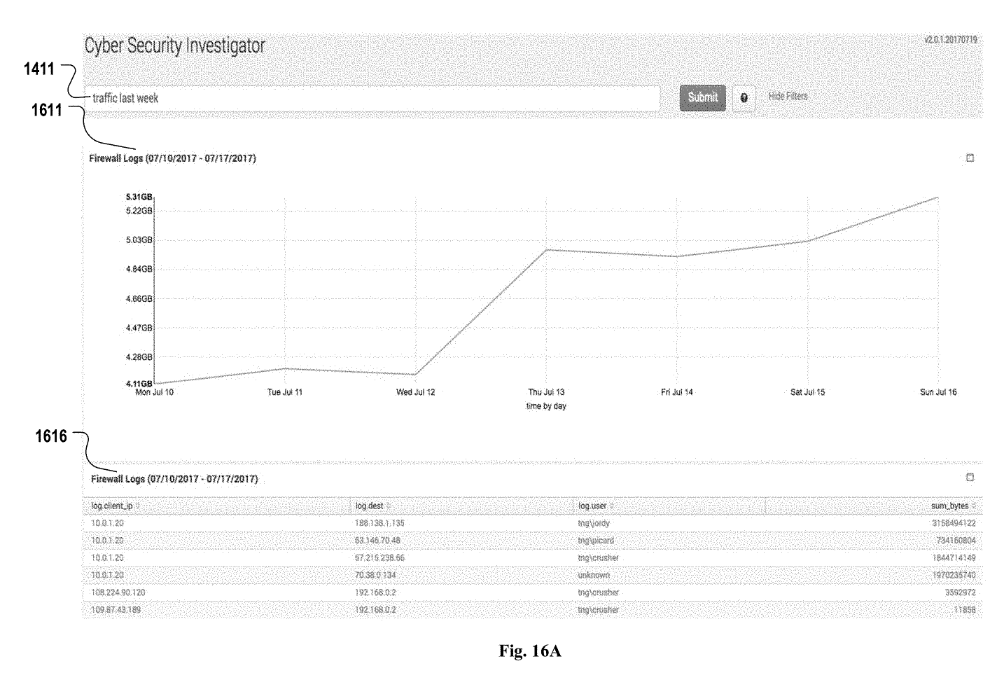

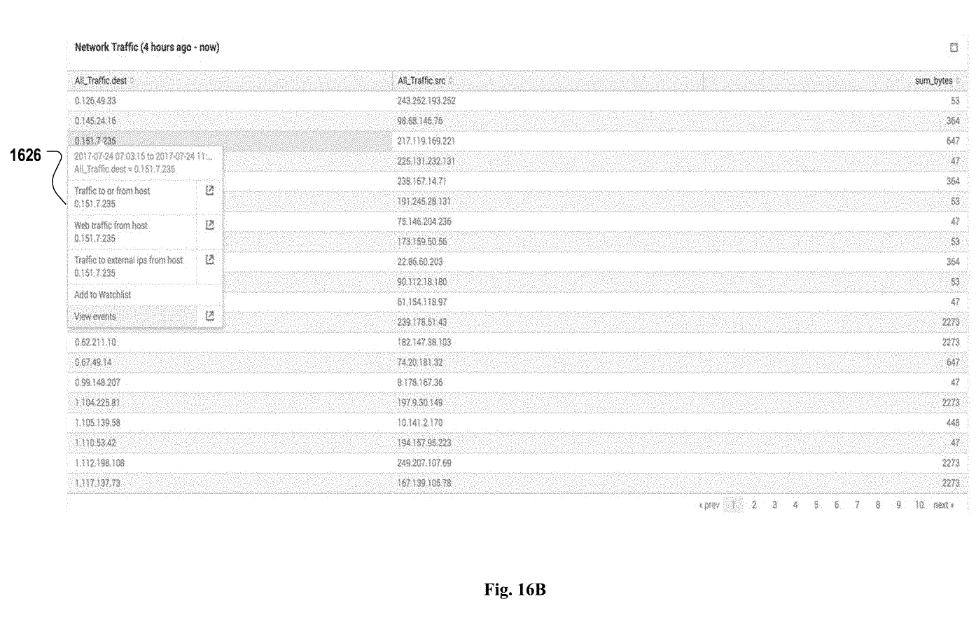

Once a query is created, it is passed to the query processor 111, which executes the query to search for and retrieve the specified data from metadata indexes 132 and datastores 142. The results are stored in a raw format similar to the tabular format shown in 1616 of FIG. 16.

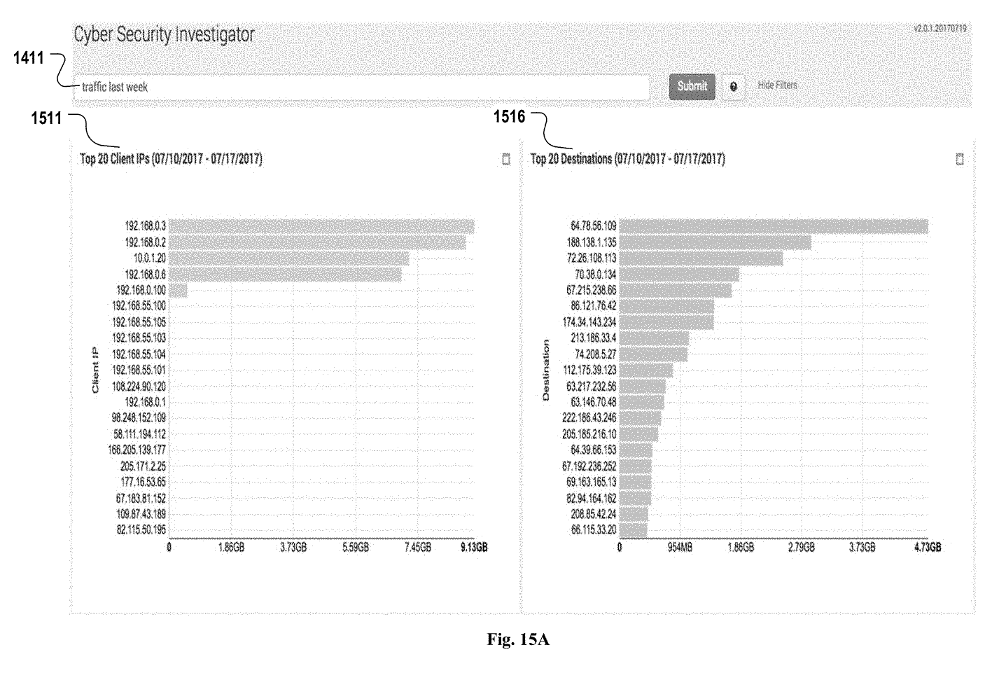

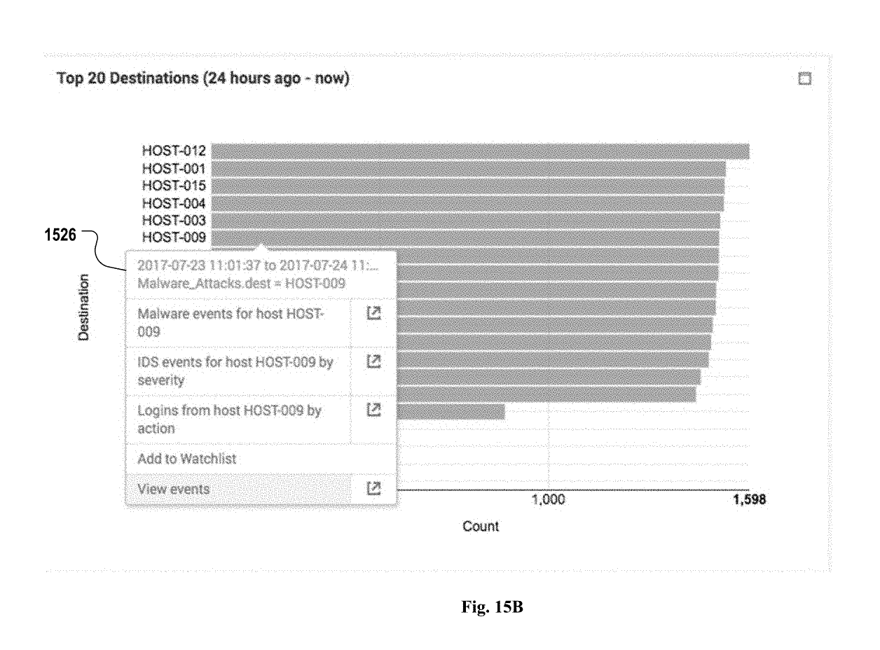

Query results are passed to the query results visualizer 149 for presentation to a user. Example visualizations shown as charts, tables and graphs are shown in 441, 541 and 641 of the use cases in FIGS. 4-6; 1511, 1516, 1611, 1616, 1811 and 1861 show examples for data taken from time series indexes in FIGS. 15-18.

FIGS. 3A-3D are screenshots of Insight Engine's Cyber Security Investigator that show natural language queries entered by a user and the equivalent SPL queries ready to be executed.

Query 311 on FIG. 3A is: “Show me malware on host ‘FOOBAR’ by virus signature and file path.” When a system is slow or appears to have been infected with malware, this would be a common starting point for investigating the underlying cause.

A query itself stated as natural language as in example 311, appears straightforward. In comparison, the resulting SPL (Splunk™'s proprietary SQL-like query language) 381 in FIG. 3A appears complex and cumbersome.

FIG. 3C shows another example query 313 “Which users logged in to host name ‘FOOBAR’ today?”, and the translated SPL query 383. FIG. 3D shows another query 315 “What network traffic was seen from host ‘FOOBAR’ by application today?”, and the resulting SPL query 385. These examples are all drawn from practical investigations in the realm of cybersecurity and IT operations.

The capability of the technology disclosed to quickly generate the SPL 381, shown in detail in FIG. 3B, offers clear advantages in to both trained analysts and novices by performing this translation automatically: a novice analyst can request results from a large and sophisticated database system with only a few words of natural language as a request or command, or a simple statement of the results desired in the manner of a web search using just keywords and Boolean operators. Likewise, a manager or executive can perform similar queries without formal training in the underlying query language.

Additionally, a trained analyst can also take advantage of this capability to generate the same queries he would have to tediously type line-by-line in SPL, thus saving considerable time and allowing him to remain focused on the investigation instead of the underlying mechanics of creating queries.

The technology disclosed is illustrated herein with examples drawn from cybersecurity and IT operations. In other implementations it can be applied to allied areas like application delivery and business analytics.

### Performance Study

The time savings using a natural language interface versus the time required for training, creating and writing an SPL query from scratch can be considerable: hours or even days depending on the skill of the user and the complexity of the query. This was put to the test in a cybersecurity exercise using a small team of physical security specialists who had an investigative mindset and understanding of basic security concepts, but were unfamiliar with cybersecurity (computers, networks, viruses, firewalls, etc.). They were not trained in writing SPL, but did know how to compose natural language queries similar to a web search using keywords, phrases, logical operators (“<” for less than, “>” for greater than, “=” for equal) and Boolean operators (AND, OR, NOT). The goal was to have them use Insight Engine's Cyber Security Investigator to bridge their skill set and enable them to investigate some common cybersecurity issues.

FIGS. 4-6 are screenshots of three of the use cases used in this study including the actual queries 421, 521 and 621 as created by the participants; the results using test data and presented as charts 441, 541 and 641; and the first few lines of the SPL generated 461, 561 and 661. Multiple SPL calls were required for each query: FIG. 3B is an example of the multiple SPL calls needed to retrieve data requested by a single query. Of course, result details and some wording have been sanitized.

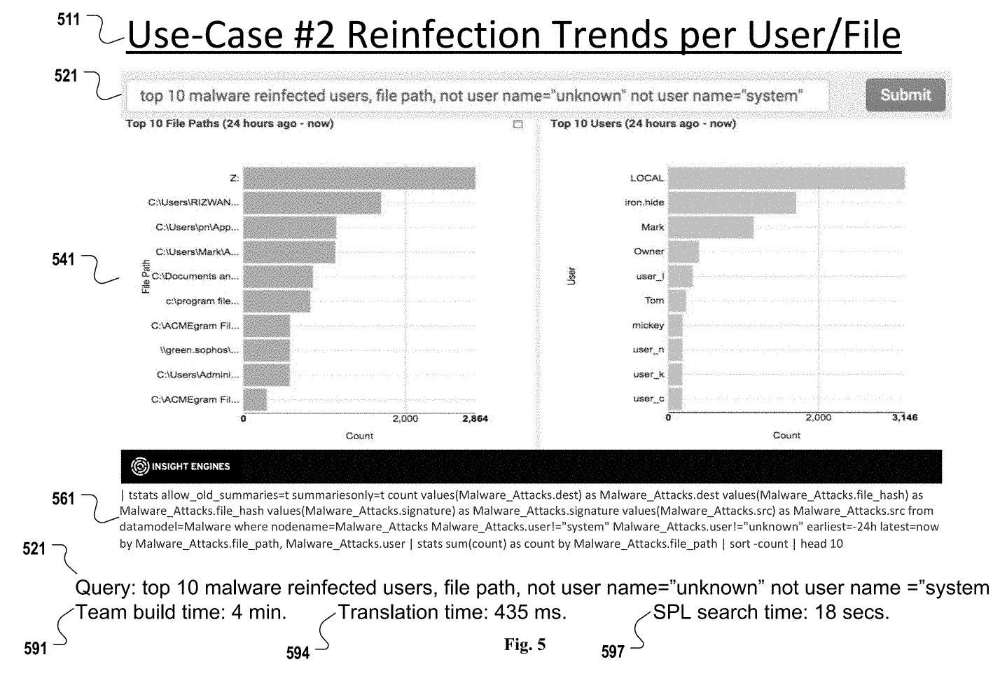

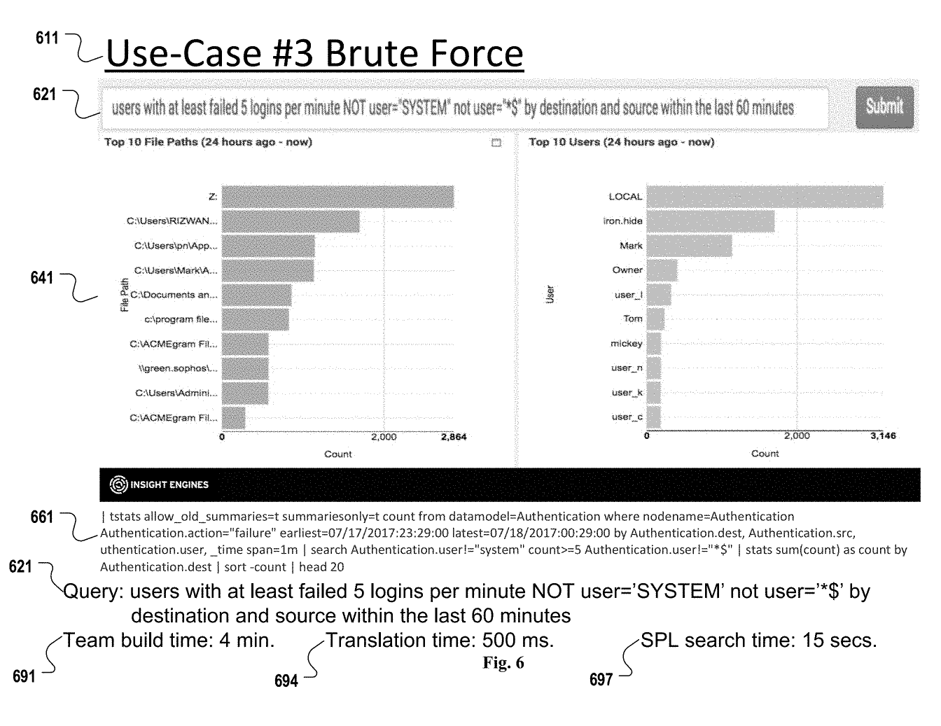

The time required for the team to build the queries is given in 491, 591 and 691. The queries in this study were built more like keyword searches with attributes, although they could have been written just as well in a more narrative form. For instance, the example query “Show me malware on host ‘FOOBAR’ by virus signature and file path” illustrated in FIGS. 3A and 3B is the same (except for the host name) as query 421 shown in 411 Use-case #1 in FIG. 4: “malware allowed by virus signature, file path, host name=“IRONHIDE-PC””. FIG. 5 shows 511 Use-Case #2 with query 521 “top 10 malware reinfected users, file path, not user name=‘unknown’ not user name=‘system’”. FIG. 6 shows 611 Use-Case #3 Brute Force with query 621 “users with at least failed 5 logins per minute NOT user=‘SYSTEM’ not user=‘*$’ by destination and source within the last 60 minutes”. These illustrate some of the many variations in natural language queries that can be processed by the technology disclosed.

Note that in all cases it took the team only a few minutes to create natural language queries that otherwise would have required them to spend hours or weeks learning SPL, determining which data models or data sources to use and so forth, in addition to writing several lines of text with exacting syntax requirements.

The time to translate the natural language queries into SPL is given in 494, 594 and 694. The SPL search times follow as 497, 597 and 697. All translation times in this test were well under a second and the corresponding search times were under a minute.

The queries in this study all involved finding infected systems. However, even if pre-configured dashboards are provided with similar queries, an analyst can be much more effective if he can ask ad-hoc questions of the data sources after discovering infected systems. These types of queries can help narrow down the timeframe of the infection and isolate the users involved.

As an example, consider a host named “BOBSHOST” that was found to be infected with a virus at 3 PM on a given Tuesday. Queries about system, user and network activity before and after this time could be useful in determining the origin and cause of the malware infection and the users and systems affected.

An initial follow-on natural language query might be “What users were logged into the system around 3 PM on Tuesday?” Now, continuing the example, say that user “Bob” was logged into the system. If it is suspected that an adversary gained control of Bob's system and logged in with his credentials then a second follow-on query might be “What accounts did user Bob modify after 3 PM Tuesday?” A third query to help determine the origin of the malware could be “Show me web traffic to host BOBSHOST before 3 PM Tuesday.” Another query to help discover the source of the malware could be “Show me email that user BOB received around 3 PM Tuesday.”

Note that vague words like “around” can be semantically translated using defaults for time-range queries that create a datetime range from, for example, 24 hours prior to the given time through 24 hours following the given time. Other “around” ranges can be plus or minus 8 hours, 4 hours, 2 hours, 30 minutes or 5 minutes. This is one of many examples that illustrate how natural language can augment human capabilities by removing the tedious and repetitive aspects of a task. More examples follow.

An investigator in physical security can use ad-hoc query capabilities to ask questions about physical locations and people present at those locations. For instance, “Who was in the secure area of building 17 after hours last night?” Another way to perform this query is “Show me personnel in building 17 secure area after hours last night.”

An IT (information technology) professional managing a large computer network can ask questions like “What systems have not been updated to the latest version of anti-virus software?” or request “Show servers scheduled for maintenance this weekend.”

An executive, perhaps a CSO (chief security officer) or CIO (chief information officer) can query “How many malware attacks this month?” Then he can follow up with “Show me users with successful malware attacks.”

There are a large number of ad-hoc questions that an investigator can ask and they need not be in any particular order. This flexibility is automatically provided by the technology disclosed and allows a user of any skill level who has a basic understanding of security to perform queries based on his mindset as an investigator. He can thereby follow leads and “pull at threads” that are based on his experience and intuition without being constrained by fixed dashboards and interfaces that expose only limited search capabilities.

FIG. 7A shows an example of a sequence of transformations for translating a natural language query to a machine executable query using the disclosed technology. The natural language query analysis 710 and the parse tree 730 transformations are performed by natural language parser and disambiguator 115 shown in FIG. 8.

This example can be implemented by one or more processors configured to receive or retrieve information, process the information, store results, and transmit the results. Other implementations may perform the actions in different orders and/or with different, fewer or additional actions than those described. Multiple actions can be combined in some implementations.

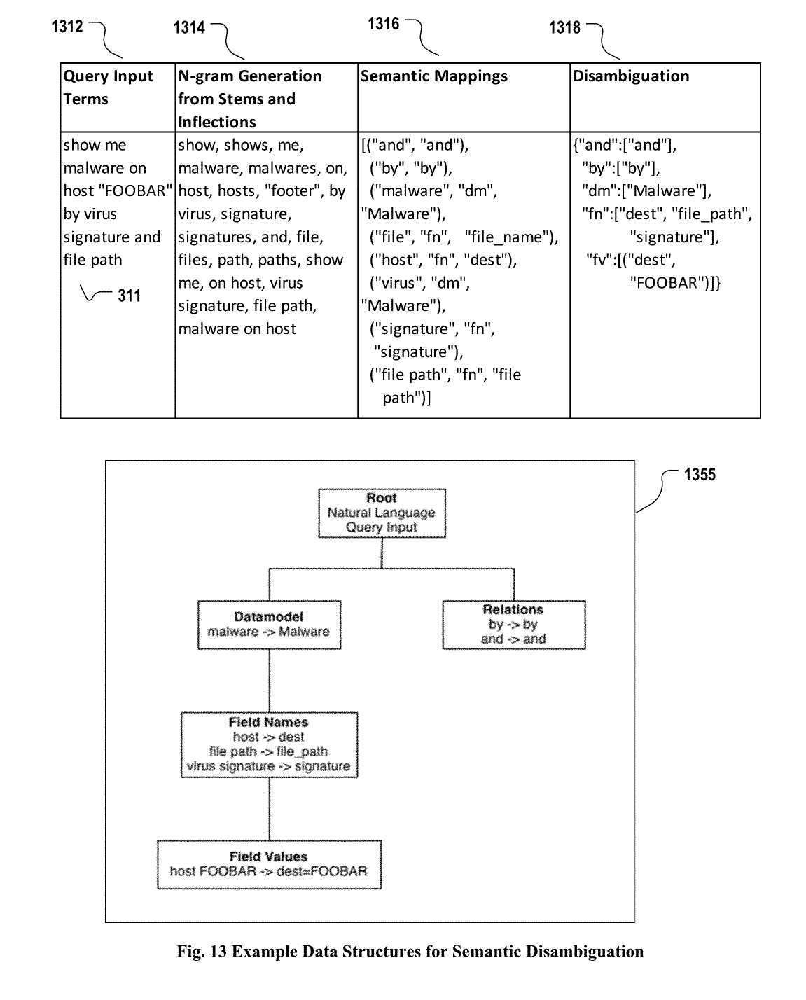

A natural language query analysis 710 of the example query 311 “Show me malware on host ‘FOOBAR’” by virus signature and file path” uses natural language parser and disambiguator 115 to identify and tag words and phrases in the query with semantic parameter mapping codes and search parameter values. A more detailed example of this process is shown in FIG. 13.

The tags, as indicated in legend 719 and 739, can refer to a data source, database or datamodel, field name, field value or relation. The resulting tagged and mapped terms (e.g., tuples) 721, containing two or three elements as shown, bind tags to each word or phrase. These tuples are then analyzed to create a parse tree 730 that shows the relationships as dependencies among the tagged terms (words and phrases) in the query. In other implementations, different types of parse trees may be used, for instance constituency-based parse trees.

The relationship hierarchy in this example is as follows: the top level tuple 733 in the datamodel is “Malware” and that indicates which database or data source to use for the search. The second level tuple 741 gives a field value of “dest” and “FOOBAR” to use as a filter, which indicates that the search should be restricted to the destination host named “FOOBAR.” The third and final level tuple 751 indicates that the particular field names to be retrieved are “signature” and “file path.”

The tuples 733, 741, 751 are passed to a query flow compiler 129 that generates a flow graph encoding the data source, filter and fields to retrieve according to the relationships determined by the parser and disambiguator 115. The flow graph should be acyclic and directed to indicate how the process should proceed: in this example, from data model to filters to field values.

The query flow compiler has knowledge of the query execution environment, including the data model, field values and field names. One way to obtain this knowledge is using introspection—the ability to query a data model and have it return a list of attributes (field names). In another implementation, this knowledge can be provided via a configuration file.

Note that a data model can also refer to a datastore, database or a data source that contains data to fulfill search queries.

There are many data models: Relational, hierarchical, object-oriented, flat file, document oriented and network are a few of the most common. The relational database model is one of the most popular for several reasons: there is a large install base, there is a well-defined database access language called SQL (structured query language) and it is easily extensible for custom usage, data may be collected and stored easily without committing to rigid access methods.

The Splunk™ data model used for the examples given can be translated into nomenclature for relational databases of tables having rows and columns. The columns in a relational database are called fields and have field names. Fields is an alternative name for attributes. The rows are records comprising one or more fields. Fields that form records in a relational database are implemented as objects with attributes in a Splunk™ data model.

In an actual installation, there are often many different data models in use, just as one could have multiple relational database schemas in use for different relational databases. As an example, a manufacturing organization could have different data models for security, personnel, facilities management, manufacturing, finance, etc. Each of these would organize its data in a manner best suited for its use: personnel records may be organized by person, location and job category. For example, security records may be organized by system name, users, malware and network traffic.

In order to perform efficient natural language queries, the data model used for the requested data is a natural starting point for a search, and the query should be validated against this data model before execution to avoid run time failures. As an example, the terms “malware”, “virus” and “infection” would be mapped to a “Malware” data model by the parser and disambiguator 115. Terms tagged as field names would be validated within the selected data model to make sure they are present. Thus, to validate the field name “virus signature” as shown in 311 of FIG. 7A, the “Malware” data model would be checked to make sure it has this field name (attribute). Likewise, the field value “dest” would be checked to make sure it exists in the data model so it can be used as a filter to narrow down the search to host “FOOBAR.”

The query flow compiler 129 collects this information and passes it to query composer 139, again as tuples like those shown in the flow graph 760 as 761, 765 and 769. The query composer 139 uses these tuples, which include filter output from the classification extraction module 874 and semantic mappings from disambiguation module 864, to generate an actual executable query specification in the Splunk™ processing language 790 as SPL code 791 shown in this example. An explanation of the code is shown in 799. This code is a simplified version of the SPL code shown in 381 of FIG. 3A.

The executable query specification is passed to query processor 111, which executes the query by searching datastores 142 and metadata indexes 132. Results are returned to query results visualizer 149 for presentation to a user.

The query results visualizer 149 generates multiple views of search results. The views can include tables, bar charts, total counts, time series charts. Many other visualizations are possible and will be known to those skilled in the art. The examples shown in FIGS. 4-6 show results as charts that can be interactive and permit a user expand individual bars into more detailed formats.

FIG. 7B shows the query 311 in FIG. 7A translated to executable queries in SPL, SQL and MongoDB. The code that converts the flow graph 760 shown in FIG. 7A to SPL is shown at 742. This is Python string manipulation code that generates an executable query from values of tuples and a code template (791, 752, 772) for the target query language. The equivalent query in SQL is shown at 752. SQL is a traditional database access language used for relational databases. A MongoDB version of the query is shown at 772. MongoDB uses a documented oriented data model that is classified as a NoSQL database. It uses JSON (Javascript Object Notation) documents with dynamic schemas.

FIG. 8 shows a flow chart of natural language parser and disambiguator 115 that performs the sequence of transformations described in 710 and 730 of FIG. 7A to generate a parse tree. The natural language parser and disambiguator 115 analyzes a query using semantic analysis to identify and tag words and phrases with search parameter mapping codes and values. Tagged and mapped terms 721 and 741 are shown in FIG. 7. These are checked for semantic validity, combined with the results from the classification extraction module 874, and used to create a parse tree 730 that formalizes the relationships among them.

The parser includes a tokenizer 804, POS (parts of speech) tagger 814, stemmer 824, inflection module 834, n-gram generator 844, coverage analyzer 854, semantic data store 852, disambiguation module 864, lexical hierarchy data store 862, classification extraction module 874 and relationship analyzer 884.

The transformation of a natural language query to a machine executable query begins with parsing the natural language query to produce a parse tree that encodes a representation of the semantic relationships among the words and phrases in the query.

Tokenizer 804 segments text into meaningful units. In natural language these are treated as words and phrases. Note that this treatment includes numbers, abbreviations, acronyms and so forth. POS (parts of speech) tagger 814 processes the tokenized units received from tokenizer 804, attaching a part of speech tag to each word or phrase.

Output from POS tagger 814 is passed directly to classification extraction module 874, which passes its output to relationship analyzer 884. The output of the POS tagger 814 is also passed in parallel to stemmer 824, which passes its output to other modules and thence to relationship analyzer 884. In other implementations, classification and extraction module need not be in parallel.

Stemmer 824 and inflection module 834 produce alternative word forms (stems, tenses, gender, etc.) for the n-gram generator 844 which generates n-grams: contiguous sequences of n terms from the given sequence of text or speech. Semantic data store 852 receives and stores input from the natural language search module 114, and provides input to coverage analyzer 854, which chooses n-gram combinations, favoring longer n-grams and more coverage of the original tokens.

Disambiguation module 864 uses the hierarchical taxonomy stored in lexical hierarchy data store 862 to select semantic mappings that resolve the meaning or usage of a word when the word can have multiple meanings. This is done by examining the context surrounding the word, by establishing relationships between it and other words in its vicinity. For example, as a noun, the word “host” in the industry of cybersecurity refers to a computer system, but in other contexts it can mean “a person who is receiving or entertaining guests” or “an animal or plant on which another organism lives.” The word “host” can also be used as a verb in all of these cases. Domain specific jargon can be identified and used to build semantic relationships with other words and phrases in a query. The semantic mappings from the disambiguation module 864 are passed to the relationship analyzer 884. Examples of semantic mappings used for search parameter codes and values are described in FIG. 13.

The POS tagged tokens are passed to the classification extraction module 874, which extracts classifications by identifying values described by the input to natural language search module 114. For example, the phrase “last three days” would be extracted, classified and tagged as a datetime value. An example of disambiguated semantic mappings is shown in FIG. 13.

The results of the classification extraction module 874 are passed to relationship analyzer 884, which produces a parse tree 730 in FIG. 7A by analyzing the relationships among the words and phrases using their POS tags, context, relative positions and linguistic dependencies. An example of a parse tree 730 is shown in FIG. 7A.

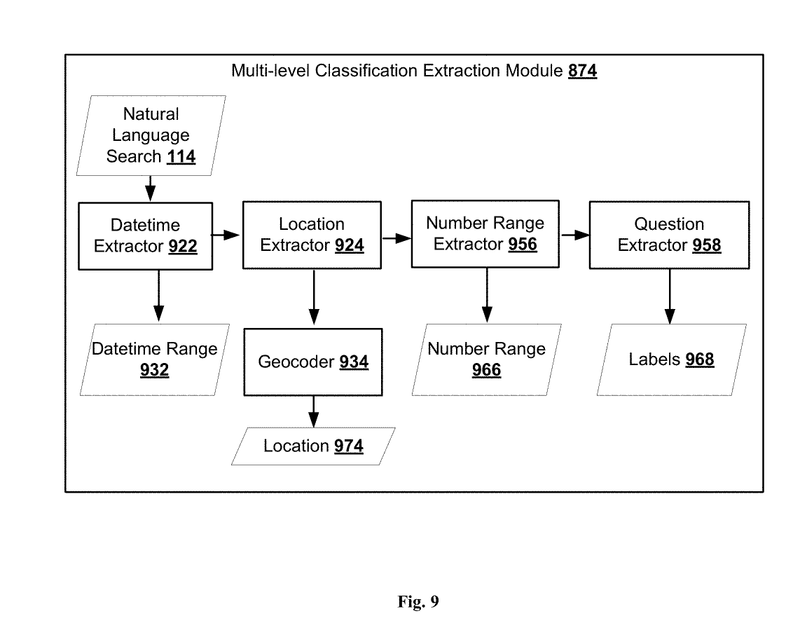

FIG. 9 shows a block diagram of classification extraction module 874.

The classification extraction module 874 extracts classifications. Each classification extractor identifies values described by the input to natural language search module 114. There can be many kinds of classification extractors: for example, an IP address extractor could be implemented as a regular expression processor because IP addresses have a standardized format and syntax. Other extractors could search for keywords and numbers in particular combinations. Yet other implementations could be adapted to use specialized syntax to process input with fixed formatting and keyword or key character delimiters.

The datetime extractor 922 outputs a datetime range 932. Example datetime input words include ‘this weekend’, ‘next Monday’ and ‘tomorrow’. These and more complicated phrases like ‘last three days” would be extracted and classified and tagged as datetime values. Location extractor 924 uses geocoder 934 and outputs location 974. Location input term examples include ‘neighborhood’, ‘cross street’, ‘zip code’, ‘address’, geocoded IP addresses, latitude-longitude coordinates and the name of a place or landmark.

Question extractor 958 decides which answer type is best, such as counts, statistics, charts, lists, etc. For instance, search data retrieved for the example query 311 may be returned as a list of file paths and corresponding virus signatures. Alternatively, a statistical value like an average of the number of malware attacks per day could be returned as a number, or perhaps aggregate values like a total count of successful malware attacks.

Results of the classification extraction module 874 can be used as search filters to restrict the items to be retrieved from a data source. A filter can be expanded or restricted as needed, to include more or fewer results, to expand or contract a datetime range or to handle varying degrees of ambiguity. Subsequent classification searches benefit from a restricted search space.

In the example implementations given, queries are input as text. While a user may enter the text directly using a keyboard or equivalent device, the text itself may also be generated via spoken words that are converted to text using speech-to-text conversion technology. Other implementations may generate queries dynamically via a software application running locally or remotely.

Natural language search with semantic mapping and classification environment 100 further includes a user computing device 155 with a web browser 175 or lightweight application 186. In other implementations, environment 100 may not have the same elements as those listed above and/or may have other/different elements instead of, or in addition to, those listed above.

In some implementations, the modules of natural language search with semantic mapping and classification environment 100 can be of varying types including workstations, servers, computing clusters, blade servers, server farms, or any other data processing systems or computing devices. Modules can be communicably coupled to the datastores 142 via a different network connection. For example, datastores 142 can be coupled to a direct network link. In some implementations, it may be connected via a WiFi link or hotspot.

In some implementations, network(s) 135 can be any one or any combination of Local Area Network (LAN), Wide Area Network (WAN), WiFi, WiMAX, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

User computing device 155 includes a web browser 175 and/or lightweight application 186. In some implementations, user computing device 155 can be a personal computer, laptop computer, tablet computer, smartphone, personal digital assistant (PDA), digital image capture devices, and the like.

In some implementations, datastores 142 can store information from one or more sources into tables of a common database image to form an on-demand database service (ODDS), which can be implemented in many ways, such as a multi-tenant database system (MTDS). A database image can include one or more database objects. In other implementations, the databases can be relational database management systems (RDBMSs), object oriented database management systems (OODBMSs), distributed file systems (DFS), no-schema database, or any other data storing systems or computing devices.

When there are unknown search terms, the terms can be classified by context. For example, for the phrase “host FOOBAR”, the word “host” would be part of the cybersecurity lexicon and therefore “FOOBAR” would be classified as the name of the host to be targeted with the query. The phrase “host FOOBAR” can be used as a filter to restrict the search and thereby speed it up.

For the disclosed natural language search with semantic mapping and classification, natural language query inputs are transformed into a search specification for a database. The parsing and disambiguation process includes a sequence of ordered transformations: tokenize string, generate n-grams, expand n-grams, select term buckets, choose best n-grams, select bucket mapping, and apply rules to generate query term mappings. The query term mappings are disambiguated on multiple common levels of classification, including datetime criteria, location criteria, and other use case-specific features. Relationships in the mappings and natural language query terms are analyzed to transform the mappings into a parse tree. The parse tree is compiled into a flow graph which then generates the search specification.

An example sequence of transformations is described in Python programing language by the parse( ) and query( ) functions below.

def parse(q):

term_mappings, terms = disambiguate(q)
return build_parse_tree(terms, term_mappings)

def query(q):

tree = parse(q)
graph = compile(tree)
return graph.make_commands( )

### Data Structure Transformations for Cyber Security Use Case

In the following examples, natural language search query entries are transformed by a series of disclosed transformations, resulting in the deep semantic understanding necessary for accurate generation of search specifications.

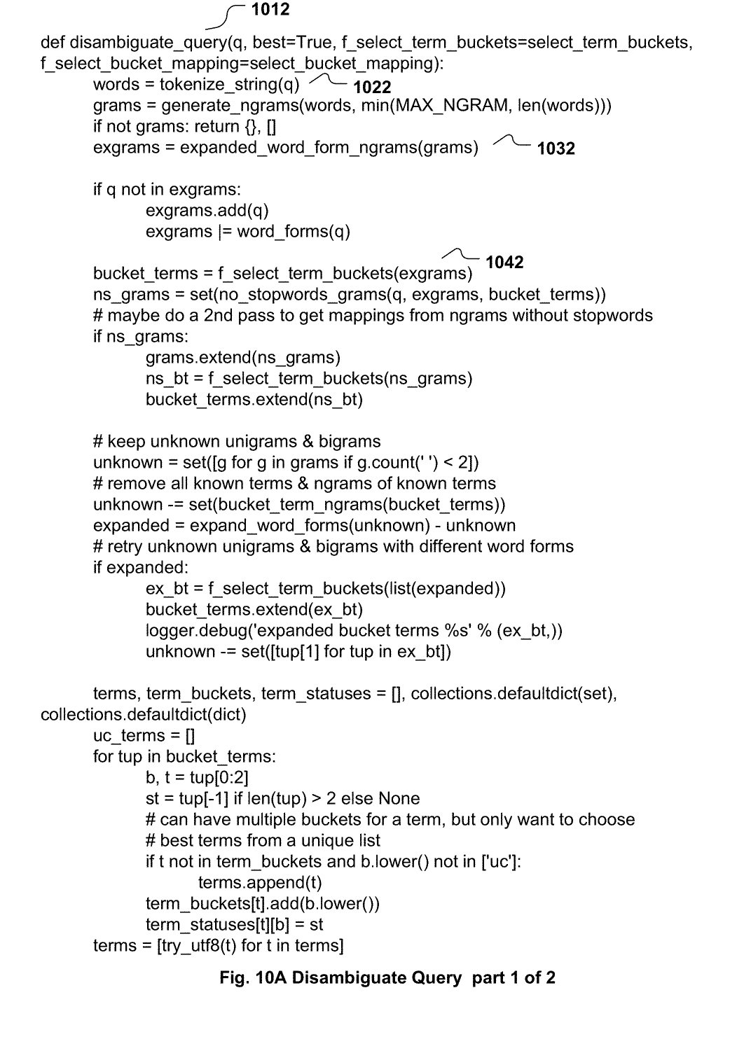

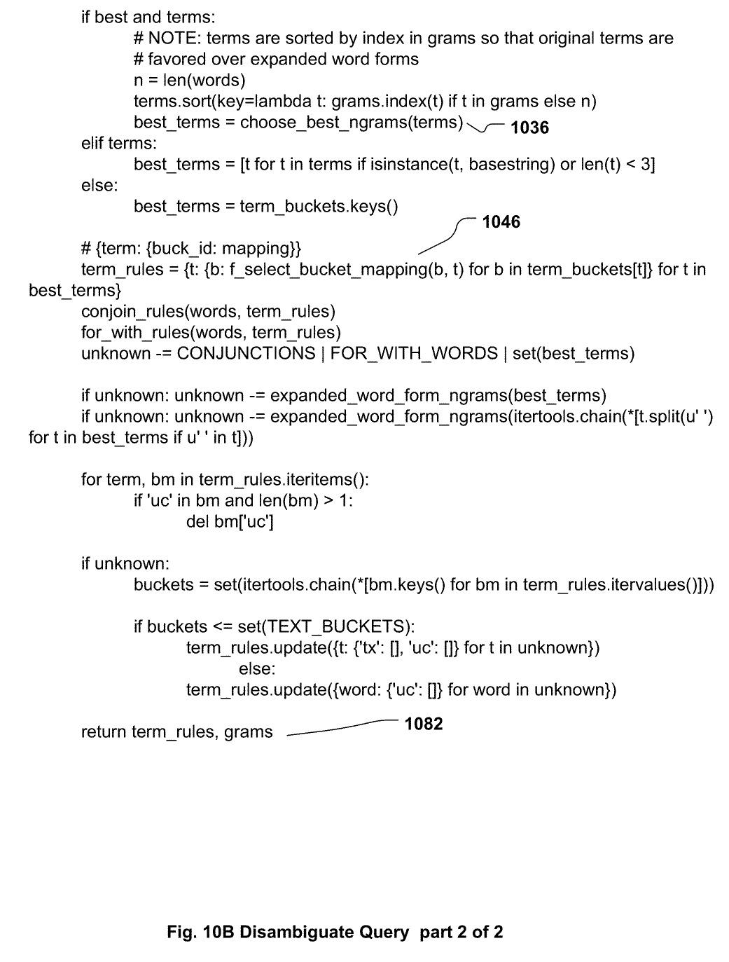

FIGS. 10A and 10B show an implementation of Python code that disambiguates search input. The parser and disambiguation module 864 includes the disambiguate query function FIGS. 10A and 10B, which includes as input the hierarchical taxonomy stored in lexical hierarchy data store 862 to select semantic mappings.

For an example input value of “failed logins yesterday”, semantic mapping outputs are:

{failed: [(fv, action, failure)],

login: [(dm, Authentication),

(fn, user)], yesterday: None}

Disambiguation categorizes “failed” as a specific value of the “action” field, i.e., “failure”. The word “yesterday” needs no disambiguation because it is handled by the datetime extractor 922. The term “logins” is disambiguated and mapped to a “datamodel” named “Authentication”, with a field name of “user”.

def disambiguate_query(q, best=True,
f_select_term_buckets=select_term_buckets,

f_select_bucket_mapping=select_bucket_mapping):

words = tokenize_string(q)
grams = generate_ngrams(words, min(MAX_NGRAM, len(words)))
if not grams: return { }, [ ]

exgrams = expanded_word_form_ngrams(grams)

At 1022 the disambiguate query function 1012 calls tokenizer 804, shown below, which segments text into meaningful units. For the example input “failed logins yesterday”, this function will find three tokens: “failed”, “logins”, and “yesterday”.

def tokenize_string(s):

return [w for w in tokenizer.tokenize(normalize_string(s).lower( ))

if w not in punctuation and w]

Identified tokens can now be used as input values to n-gram generator 844 to generate n-grams. The results include the following set of six n-grams, ranging from one word to three words: “failed”, “logins”, “yesterday”, “failed logins”, “logins yesterday”, “failed logins yesterday”. If word order permutations are a consideration in an implementation, additional n-grams can be found: “logins failed”, “yesterday logins”, “logins failed yesterday”, “logins yesterday failed”, “failed yesterday logins”, “yesterday failed logins” and “yesterday logins failed”. The length of the possible n-grams depends on the number of words in the query, and can have a static maximum length. In an alternative implementation, n-gram length can be variable.

The n-grams can now be mapped at 1032 to extended word form n-grams via stemmer 824 and inflection module 834, combining the same words in different forms (plurals and spellings in this case). The results are “failed”, “faileds”, “login”, “logins”, “yesterday”, “failed logins”, “failed login”, “faileds login”, “faileds logins”, “login yesterday”, “logins yesterday”, “failed logins yesterday”, “failed login yesterday”, “faileds login yesterday” and “faileds logins yesterday”.

Disambiguation continues, selecting buckets for the expanded n-grams. The function for selecting term buckets is shown below, and is called at 1042 by disambiguate query function 1012, shown in FIGS. 10A-10B. Buckets are selected as keys and one or more canonical word values recognized as associated with the key. The bucket key value results are (fv, failed), (dm, login). The word “yesterday” can be ignored because it has no bucket. In some implementations, stop words such as “but” are removed.

def select_term_buckets(terms, cursor=None):

q = SELECT_TERM_BUCKETS % u‘,’.join([‘%sterm%d%s’ %

(‘%(‘, i, ’)s’) for i in range(len(terms))])

args ={‘term%d’ % i: t for i, t in enumerate(terms)}
return fetch_rows(q, args, cursor=cursor)

The disambiguation transformation continues, using the n-grams as inputs to choose the best n-grams, via the choose best ngrams function at 1036, with results “failed” and “login”. In general, ranking favors n-grams with more words, and n-gram combinations that cover more words in the query.

Code enclosed in a pair of triple quotes is included for a Python doctest that demonstrates the input and output expectations of the function. Doctest searches for text that looks like interactive Python sessions, and then executes those sessions to verify that they work as expected. In the example shown below, for an input of [“web”, “traffic”, “web traffic”, “yesterday”] the expected best n-gram outputs are [“web traffic”, “yesterday”].

def choose_best_ngrams(terms):

“““
>>> choose_best_ngrams([“t1 t2”, “t1”, “t2”])
[“t1 t2”]
>>> choose_best_ngrams([“t1 t2”, “t1 t3”, “t2”])
[“t1 t2”, “t1 t3”]
>>> choose_best_ngrams([“web”, “traffic”, “web traffic”,
“yesterday”]}
[“web traffic”, “yesterday”]
”””
return ranked_ngrams(terms)[0][0]

After choosing the best n-grams, bucket mapping follows as shown below, based on the best n-grams and term buckets. Semantic data is found, via the select bucket mapping function at 1046, based on n-gram & bucket inputs, and the values are later used for the database lookup. Bucket mapping results for the example in our use case are {failed: (fv, action, failure), login: (dm, Authentication), yesterday: None}. At 1082 term rules and n-grams are returned and used as semantic mappings made available to classification extraction module 874.

def select_bucket_mapping(buck_id, term):

if buck_id in TERM_MAPPINGS: return term
if buck_id not in BUCKET_SELECTS: return {buck_id: None}
args = {“term”: term, “buck_id”: buck_id, “lang_id”: “en”}
rows = fetch_rows(BUCKET_SELECTS[buck_id], args)
return rows

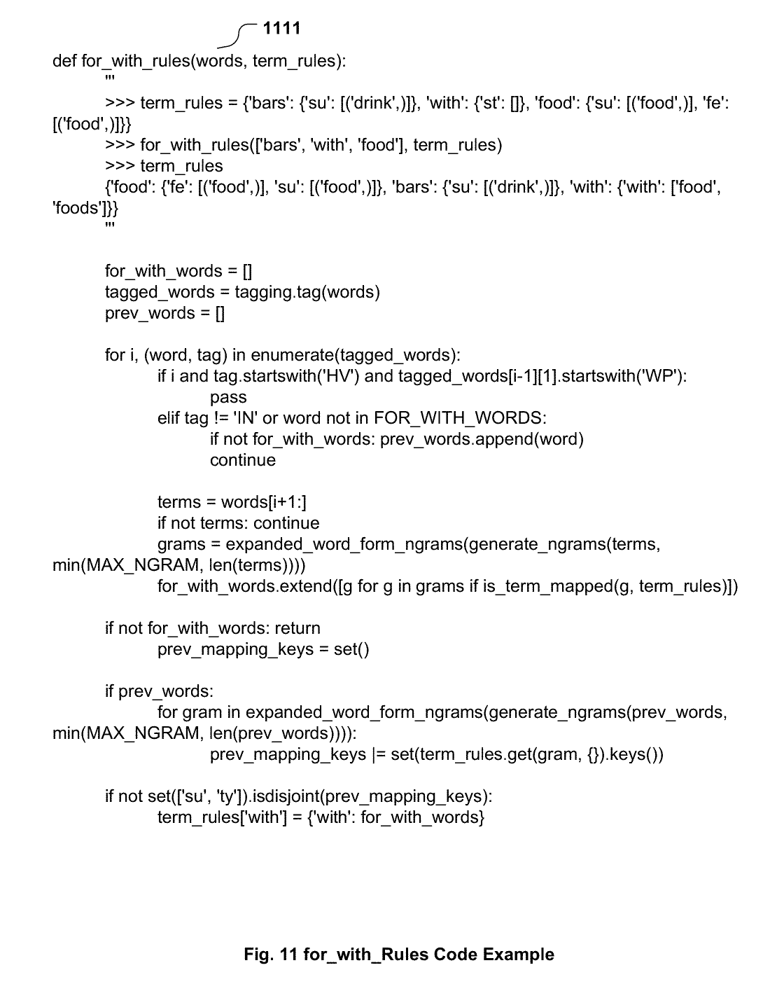

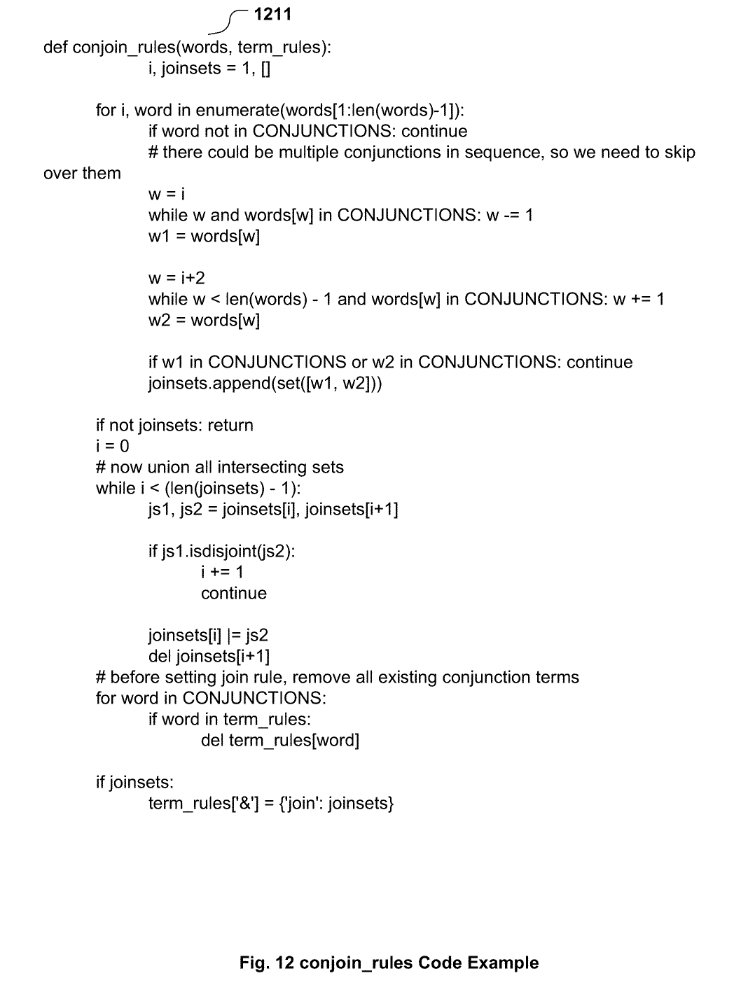

Term rules returned by disambiguate query function 1012 are available for use by the for with rules function 1111 in FIG. 11 and conjoin rules 1211 in FIG. 12.

FIGS. 11-12 show Python code for that handles “for” and “with”, and “conjunctions.” The two functions, for with rules function 1111 and conjoin rules 1211, apply rules that combine multiple criteria derived from words of the natural language search that include “and”, “with” and “or”. In some implementations, additional keys can be added to handle special terms. For example, an “&” can be treated the same as “and” by adding a key that contains references to the terms to be combined. Other instances will be familiar to those having skill in the art.

By analyzing semantic relationships between term mappings, the relationship analyzer 884 builds a parse tree 730 in FIG. 7A that is made available to the query flow compiler 129. The compiler uses the parse tree to create a flow graph (see example at 760 of FIG. 7A) representing a logical order of operations. In this example implementation, the first element in the graph is a datasource, such as “Malware”. In an alternative implementation it can be a reference to any source that provides data or access to data. For example, it can refer to a real time data stream. The compiler looks for a “dm” mapping in the parse tree 730 in FIG. 7A, and validates that the mapping value is a valid datasource, by using contextual knowledge from the local environment. Optional field filters can be attached to the datasource, such as “Malware.dest=FOOBAR”. These filters are identified in the parse tree 730 in FIG. 7A with the “fv” mapping code. The compiler validates that the filter field (Malware.dest) is a valid field for the datasource (Malware). The final element in the example flow graph in this implementation is a display element, specifying fields to display, such as “Malware.signature”. In an alternate implementation it could be a module or process; for instance a module that renders HTML or a process that generates a video data stream or a file that contains information to be displayed. Display fields can be identified with the “fn” mapping code, and the compiler validates that the fields are valid for the datasource. The compiler links the elements of the flow graph together, and makes the flow graph available to the query composer 139.

The query composer 139 uses the flow graph to produce a query specification for the query processor 111. The flow graph elements implement functions that can generate the final query. Below is a sample make_table_command function for generating SPL from a display element.

def make_table_command(self):
return “|table % s” % “, ”.join(self.fields)

In the three data structure examples shown below, term mappings and SPL query results are shown for three natural language queries: “failed logins yesterday”, “web traffic yesterday”, and “show me malware on host ‘FOOBAR’ by virus signature and file path”, with term mappings and SPL query listed.

“failed logins yesterday” −> term_mappings =
{
“failed”: [(fv, action, failure)],
“login”: [(dm, Authentication), (fn, user)],
“yesterday”: None
}
−> SPL query =
| tstats count from datamodel=Authentication where
Authentication.action=“failure” earliest=−48h latest=−24h by
Authentication.user
“web traffic yesterday” −> term_mappings =
{
“web traffic”: [(dm, Web), (fn, url)],
“yesterday”: None
}
−> SPL query =
| tstats count from datamodel=Web where earliest=−48h latest=−24h
by Web.url
“show me malware on host ‘FOOBAR’ by virus signature and file
path” −>

term_mappings =

{
“malware”: [(dm, Malware)],
“host FOOBAR”: [(fv, dest, FOOBAR)],
“virus signature”: [(fn, signature)],
“file path”: [(fn, file_path)]
}
−> SPL query =
| tstats count from datamodel=Malware where
Malware.dest=“FOOBAR” by
Malware.file_path, Malware.signature

FIG. 13 shows an example set of transformations from natural language input to disambiguated semantic mappings: from query input terms 1312 to n-gram generation from stems and inflections 1314, to semantic mappings 1316, to disambiguation 1318 with feature key-value relationships. The natural language query 311 is shown in the column labeled query input terms 1312. From this query several n-grams illustrated in the column labeled n-gram generation from stems and inflections 1314 are generated as the query is transformed via the modules shown in FIG. 8: tokenizer 804 extracts terms as words and phrases from the query, POS tagger 814 tags the terms with parts of speech, stemmer 824 identifies stems for the terms, inflection module 834 add inflections including plural and singular forms and n-gram generator 844 generates n-grams as shown in 1314.

Coverage analyzer 854 accesses semantic data store 852 to calculate a weighted score for each n-gram and produce search parameter mapping codes and values. As an example, an n-gram with mapping codes that covers one word of a query receives one point. An n-gram with mapping codes that covers two words receives two points and so forth. Additional weight may be assigned to larger n-grams with mapping codes: for instance, an n-gram with mapping codes that covers three words may receive four points. The combination of n-grams with mapping codes that has the most points is then considered to be the combination with the greatest coverage of the query.

Once a set of n-grams has been generated and selected, it is sent to disambiguation module 864, which uses a hierarchical taxonomy stored in lexical hierarchy data store 862 to select semantic mappings that resolve the meaning or usage of a word when the word can have multiple meanings. These semantic mapping codes and values are shown in the column labeled disambiguation 1318 of FIG. 13 and as a tree structure 1355 for natural language query 311.

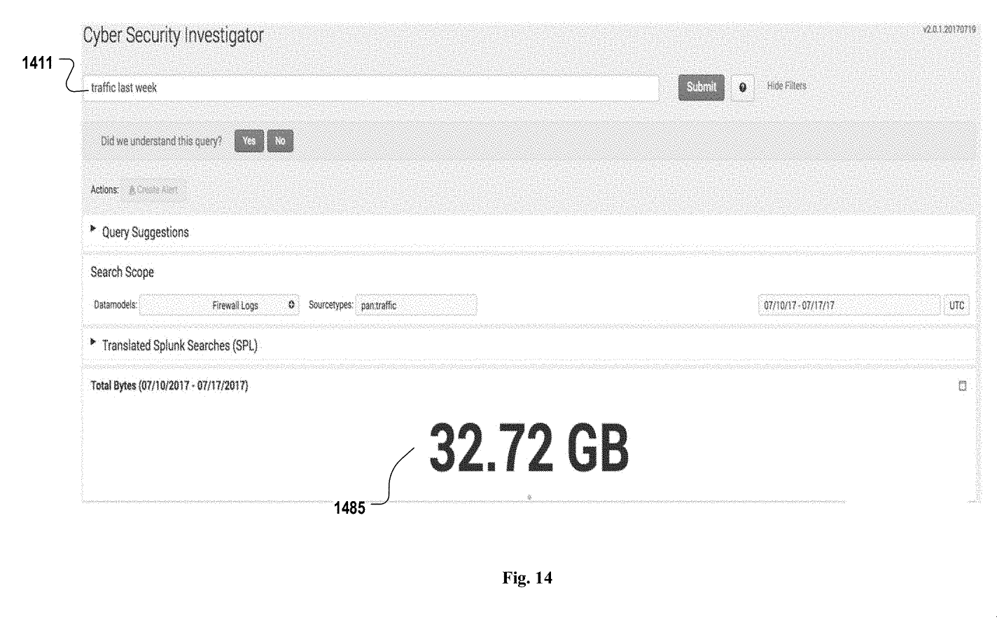

FIGS. 14-18 show example screenshots of results from queries that use time series index data. FIG. 14 shows the query “traffic last week” that yields an aggregate result 1485 of 32.72 GB. The time range here is “last week” (from Jul. 10, 2017 to Jul. 17, 2017).

FIG. 15A shows the top 20 client IP addresses 1511 and destinations 1516 for the query 1411 in FIG. 14.

FIG. 15B shows a drill down view 1526 of top 20 destinations in FIG. 15A. This drill down view displays detailed malware related information when a user clicks on any IP address in FIG. 15A.

FIG. 16A shows firewall logs for the query 1411 in FIG. 14. Chart 1611 plots the size of the logs in gigabytes (GB) versus time in days. The amount of traffic in bytes from selected IP addresses to selected destinations is given on a per user basis at 1616.

FIG. 16B shows a drill down view 1626 of network traffic related information in FIG. 16A. This drill down view 1626 is displayed when a user clicks on any IP address in FIG. 16A.

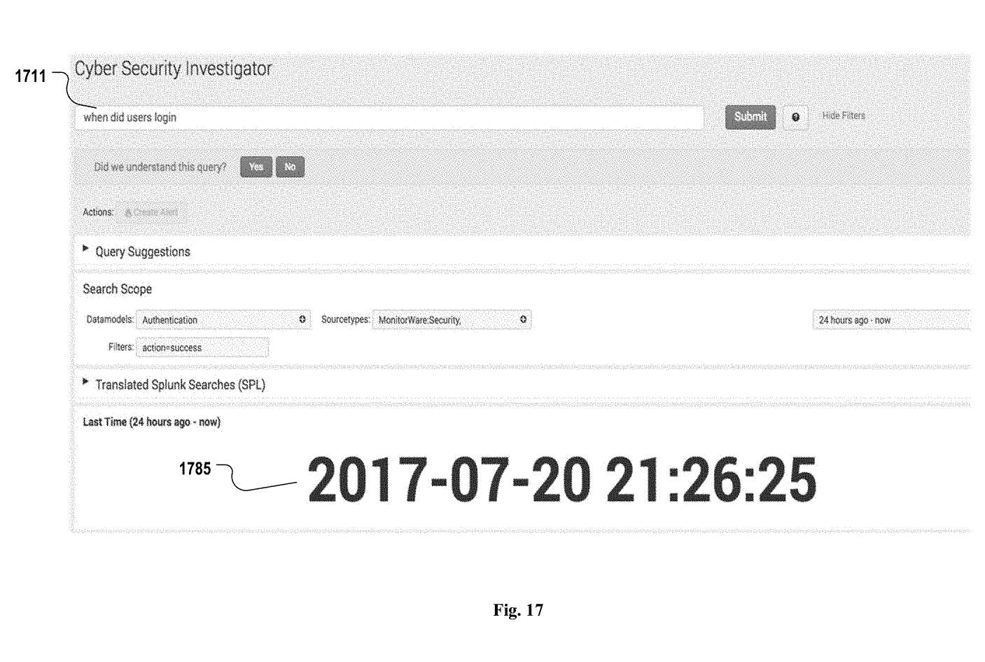

FIG. 17 shows the query 1711 “when did users login” with the result 1785, which indicates that the first user logged in Jul. 20, 2017 at 21:26:25 hours.

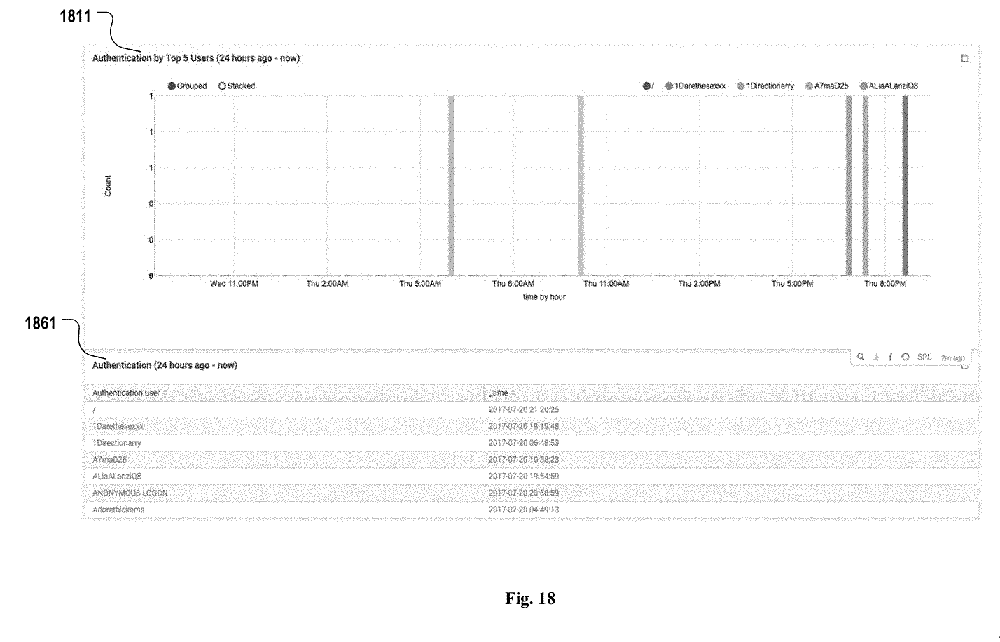

FIG. 18 shows the authentication times of the top five users within the previous 24 hour period. These results are displayed as a chart 1811 and in tabular format 1861.

The disclosed technology includes a customized search filter to restrict items to be retrieved from a metadata index. An advantage of restricting retrieval to a metadata index is that significant search time reductions can be obtained. However, in alternate implementations, retrieval can utilize both a metadata index and datastores.

When using metadata indexes, raw data can be pre-processed as desired and the results organized for efficient retrieval according to the nature of the index. Aggregate values, including statistics and counts can be calculated and stored in the metadata index to save time when queries request or make use of such values.

One type of metadata index that can be useful in the cybersecurity domain and other time sensitive domains or environments is a time series index. This type of index, since it is designed to be accessed using a time-range query that includes a datetime or a datetime range, can significantly accelerate searches that include a reference to time. It can speed up searches even more if it is has a fast access time: it can be physically proximal to the computer system performing the search and accessible via a high speed memory bus; it can be stored on a solid state drive versus traditional hard drive media; it can be remotely located with respect to the system and accessed via a high speed communications link or a high speed data network. In some implementations, metadata indexes can be accessed virtually using a high speed link so as to appear local to the system performing a search.

Metadata indexes 132 used in the example implementation herein are time series indexes and are filled with data extracted from datastores 142 using an extraction specified in Splunk™'s SPL, an SQL-like query language. The extraction and subsequent storage into time series indexes occurs a short time after data is stored in datastores 142, ranging from approximately one minute to several minutes, depending on the environment.

The extraction specification acts as a schema that specifies which fields to extract, an optional transformation of the fields, and their respective storage formats for the time series indexes. In this example, the data includes logs containing data relevant to cybersecurity and IT operations. These logs can be from multiple sources. Fields common to some or all of the logs can be extracted and stored in the time series indexes for efficient retrieval. Examples utilizing a time series index are shown in FIGS. 14-18.

In other implementations, location specific metadata indexes may be used to accelerate queries. In yet other implementations, indexes that provide access via IP addresses of known malware sites, spam email sites, lists of hacked user names or email addresses. Other instances will be familiar to those having skill in the cybersecurity domain.

As described earlier, classification extraction module 874 extracts classifications, such as date and time range criteria, price range criteria, etc. Any number of classifiers and extractors can be included. For example, many searches are restricted to a date and time range, such as the “yesterday” input in the example described earlier. Datetime functions determine the exact range to use, and then remove any associated terms from the query. The resulting output query becomes “web traffic” plus tomorrow's date and time range. An example implementation of the search when until function definition is shown below, and includes consideration of time zone, “tzinfo”.

def search_when_until(q, location, term_mappings, terms):

tzinfo = datelib.local_timezone(location=location)
now = datetime.datetime.now(tzinfo).replace(tzinfo=tzinfo)
return search_when_until_from_now(q, now, term_mappings,
terms)

Each extracted classification, such as datetime described above, identifies and removes query input terms from natural language search module 114 in FIG. 9, so that subsequent searches benefit from a restricted search space. Location extractor 924 uses geocoder 934 and outputs location 974. The natural language search module 114 may specify a location, while stored records contain IP addresses. In this case, the location would be extracted from the query and used for filtering with GEO-IP lookups. Number range extractor 956 produces a number range 966 and can include units, such as bytes, or percentages, as in 80% CPU usage. Question extractor 958 produces labels 968 that indicate which answer type is best, such as counts, statistics, charts, lists, etc. Query composer 139 in FIG. 1 uses the flow graph produced by the compiler, which contains the extracted classifications, to compose a query specification to send to the query processor 111 in FIG. 1.

Query processor 111 receives and uses the query specification from query composer 139 to search datastores 142 and metadata indexes 132. No blunt text search need be performed because the generated query contains an inclusive meaning for each query input term as part of the database filters, as well as possible aggregation functions, which can be calculated efficiently when using a time series index.

The query composer 139 may optionally generate a “base search” as well as “post process searches”. The “base search” can query data from the datastores 142 and metadata indexes 132, while the “post process searches” can do aggregations and transformations on the data from the “base search”. For example, a “base search” might do a “count” aggregation over multiple fields, while a “post process search” could do a “sum” aggregation over all the counts, to produce a total count. A different “post process search” could do a “sum” aggregation for a single field, then sort the results to show the 10 values of the field with the highest count (i.e. “top 10 field values”). The types of “post process searches” shown will depend on the data available, as well as semantic mappings in the natural language query. For example, the term “rare” may imply that the query visualizer should show values with the lowest count, where as “top” could imply showing values with the highest count. And a term like “over time” can imply that a time chart visualization should be displayed.

### Computer System

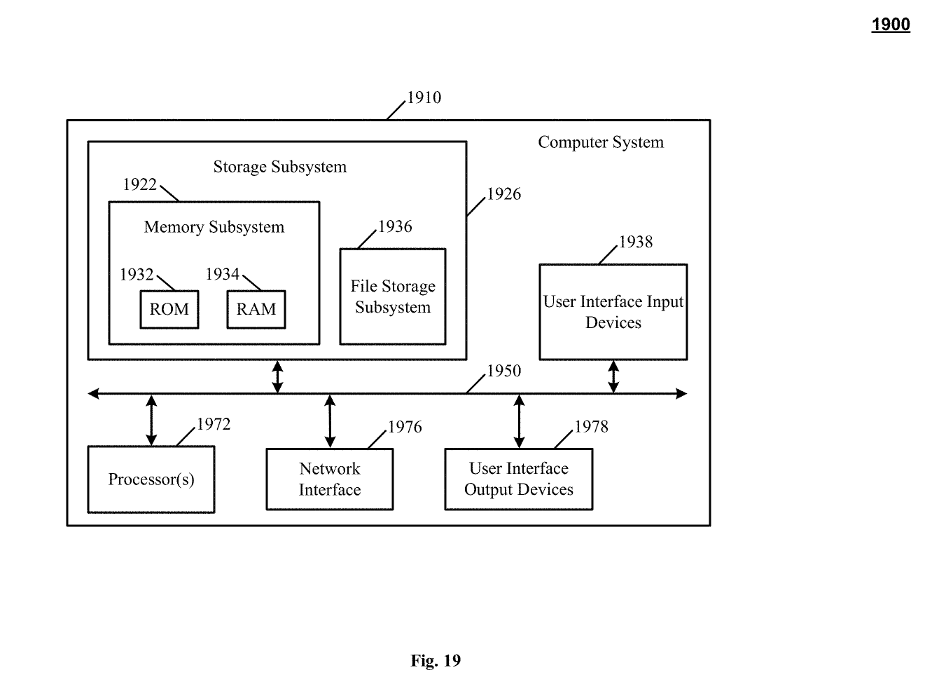

FIG. 19 is a block diagram of an example computer system 1900 for implementing a natural language search with semantic mapping and classification system, according to one implementation. The processor can be an ASIC or RISC processor. It can be an FPGA or other logic or gate array. It can include graphic processing unit (GPU) resources. Computer system 1910 typically includes at least one processor 1972 that communicates with a number of peripheral devices via bus subsystem 1950. These peripheral devices may include a storage subsystem 1926 including, for example, memory devices and a file storage subsystem, user interface input devices 1938, user interface output devices 1978, and a network interface subsystem 1976. The input and output devices allow user interaction with computer system 1910. Network interface subsystem 1976 provides an interface to outside networks, including an interface to corresponding interface devices in other computer systems.

User interface input devices 1938 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include the possible types of devices and ways to input information into computer system 1910.

User interface output devices 1978 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include the possible types of devices and ways to output information from computer system 1910 to the user or to another machine or computer system.

Storage subsystem 1926 stores programming and data constructs that provide the functionality of some or all of the modules and methods described herein. These software modules are generally executed by the at least one processor 1972 alone or in combination with other processors.

Memory 1922 used in the storage subsystem can include a number of memories including a main random access memory (RAM) 1934 for storage of instructions and data during program execution and a read only memory (ROM) 1932 in which fixed instructions are stored. A file storage subsystem 1936 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 1936 in the storage subsystem 1926, or in other machines accessible by the processor.

Bus subsystem 1950 provides a mechanism for letting the various components and subsystems of computer system 1910 communicate with each other as intended. Although bus subsystem 1950 is shown schematically as a single bus, alternative implementations of the bus subsystem may use multiple busses.

Computer system 1910 can be of varying types including a workstation, server, computing cluster, blade server, server farm, or any other data processing system or computing device. Due to the ever-changing nature of computers and networks, the description of computer system 1910 depicted in FIG. 19 is intended only as one example. Many other configurations of computer system 1910 are possible having more or fewer components than the computer system depicted in FIG. 17.

### Particular Implementations

In one implementation, a method of expanding a natural language query in a security or operations domain into an executable search query includes tagging parts of the natural language query with search parameter mapping codes. It further includes equating the parts of the natural language query with search parameter values that are semantically valid for respective search parameter mapping codes. It continues with constructing a parse tree that expresses dependencies among the tagged parts of the natural language query, and using search query objects derived from the constructed parse tree to generate an executable search query. Either as part of the method or subsequently, the executable search query is submitted to a search engine.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

The semantically valid search parameter values can be data sources, field names and values stored in fields having the field names. These data sources, field names and values can contain results of network operations and cyber-security measures. Alternatively, results of IT operations or of physical security measures.

The search query objects can be derived from the constructed parse tree by compiling the parse tree into any acyclic flow of search query objects connected as a directed acyclic graph.

One or more dictionaries can store the semantically valid search parameter values for data sources, field names and values stored in fields having the field names. Such dictionaries are modifiable dynamically by including direct feedback from a user and/or by analyzing prior natural language and query language training pairs using machine executable search query. Some implementations include comparing the generated query to previous queries and suggesting one of the previous queries to a user before running the generated query.

Some implementations use a time series index that accelerates time-range queries. The executable search query can be expressed in SPL search processing language developed by Splunk™, in SQL structured query language or another query language.

Other implementations may include a computer implemented system to perform any of the methods described above. Yet another implementation includes a tangible computer-readable storage medium including computer program instructions that cause a computer to implement any of the methods described above. A tangible storage medium excludes, for purposes of this application, a non-patentable transitory signal. The technology disclosed can be implemented using a transitory signal to convey an article of manufacture, but the term “tangible computer-readable storage medium” does not cover such transitory signals. Still other implementation includes a tangible computer-readable storage medium including computer program instructions that, when combined with suitable computer hardware, produce a device that performs any of the methods described above.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

What is claimed is:

1. A method of expanding a natural language query in a security or operations domain into an executable search query, including:
tagging parts of the natural language query with search parameter mapping codes;
equating the parts of the natural language query with search parameter values that are semantically valid for respective search parameter mapping codes;
constructing a parse tree that expresses dependencies among the tagged parts of the natural language query;
using search query objects derived from the constructed parse tree to generate an executable search query; and
submitting the executable search query to a search engine.

2. The method of claim 1, wherein the semantically valid search parameter values are data sources, field names and values stored in fields having the field names.

3. The method of claim 2, wherein the data sources, field names and values contain results of network operations and cyber-security measures.

4. The method of claim 2, wherein the data sources, field names and values contain results of IT operations.

5. The method of claim 2, wherein the data sources, field names and values contain results of physical security measures.

6. The method of claim 1, further including:
one or more dictionaries that store the semantically valid search parameter values for data sources, field names and values stored in fields having the field names; and
the dictionaries are modifiable dynamically by including direct feedback from a user and also by analyzing prior natural language and query language training pairs; and
comparing the generated query to previous queries and suggesting one of the previous queries to a user before running the generated query.

7. The method of claim 1, further including providing a time series index that accelerates time-range queries.

8. The method of claim 1, wherein the executable search query is expressed in SPL search processing language developed by Splunk™.

9. The method of claim 1, wherein the executable search query is expressed in SQL structured query language.

10. The method of claim 1, wherein the search query objects are derived from the constructed parse tree by compiling the parse tree into an acyclic flow of search query objects connected as a directed acyclic graph.

11. A computer implemented device including a processor, a network adapter coupled to the processor and memory coupled to the processor, the memory holding instructions that, when executed on the processor, implement a method of expanding a natural language query in a security or operations domain into an executable search query, including:
tagging parts of the natural language query with search parameter mapping codes;
equating the parts of the natural language query with search parameter values that are semantically valid for respective search parameter mapping codes;
constructing a parse tree that expresses dependencies among the tagged parts of the natural language query;
using search query objects derived from the constructed parse tree to generate an executable search query; and
submitting the executable search query to a search engine.

12. The computer implemented device of claim 11, wherein the semantically valid search parameter values are data sources, field names and values stored in fields having the field names.

13. The computer implemented device of claim 12, wherein the data sources, field names and values contain results of network operations and cyber-security measures.

14. The computer implemented device of claim 12, wherein the data sources, field names and values contain results of IT operations.

15. The computer implemented device of claim 12, wherein the data sources, field names and values contain results of physical security measures.

16. The computer implemented device of claim 11, wherein the instructions, when executed on the processor, implement the method further including:
one or more dictionaries that store the semantically valid search parameter values for data sources, field names and values stored in fields having the field names;
the dictionaries are modifiable dynamically by including direct feedback from a user and also by analyzing prior natural language and query language training pairs; and
comparing the generated query to previous queries and suggesting one of the previous queries to a user before running the generated query.

17. The computer implemented device of claim 11, wherein the instructions, when executed on the processor, implement the method further including providing a time series index that accelerates time-range queries.

18. The computer implemented device of claim 11, wherein the search query objects are derived from the constructed parse tree by compiling the parse tree into an acyclic flow of search query objects connected as a directed acyclic graph.

19. A tangible computer readable media holding instructions that, when executed on a processor, cause the processor to implement a method of expanding a natural language query in a security or operations domain into an executable search query, including:
tagging parts of the natural language query with search parameter mapping codes;
equating the parts of the natural language query with search parameter values that are semantically valid for respective search parameter mapping codes;
constructing a parse tree that expresses dependencies among the tagged parts of the natural language query;
using search query objects derived from the constructed parse tree to generate an executable search query; and
submitting the executable search query to a search engine.

20. The tangible computer readable media of claim 19, wherein the semantically valid search parameter values are data sources, field names and values stored in fields having the field names.

21. The tangible computer readable media of claim 20, wherein the data sources, field names and values contain results of network operations and cyber-security measures.

22. The tangible computer readable media of claim 20, wherein the data sources, field names and values contain results of IT operations.

23. The tangible computer readable media of claim 20, wherein the data sources, field names and values contain results of physical security measures.

24. The tangible computer readable media of claim 19, wherein the instructions, when executed on the processor, implement the method further including:
one or more dictionaries that store the semantically valid search parameter values for data sources, field names and values stored in fields having the field names; and
the dictionaries are modifiable dynamically by including direct feedback from a user and also by analyzing prior natural language and query language training pairs; and
comparing the generated query to previous queries and suggesting one of the previous queries to a user before running the generated query.

25. The tangible computer readable media of claim 19, wherein the instructions, when executed on the processor, implement the method further including providing a time series index that accelerates time-range queries.

26. The tangible computer readable media of claim 19, wherein the search query objects are derived from the constructed parse tree by compiling the parse tree into an acyclic flow of search query objects connected as a directed acyclic graph.
